(19) United States
(12) Patent Application Publication
(10) Pub. No.: US 2014/0018124 A1
(43) Pub. Date: Jan. 16, 2014

(54) APPARATUS AND METHOD FOR PERFORMING POWER HEADROOM REPORT

(71) Applicants: Jae Hyun Ahn, Seoul (KR); Ki Bum Kwon, Seoul (KR); Myung Cheul Jung, Seoul (KR)

(72) Inventors: Jae Hyun Ahn, Seoul (KR); Ki Bum Kwon, Seoul (KR); Myung Cheul Jung, Seoul (KR)

(73) Assignee: Pantech Co., Ltd., Seoul (KR)

(21) Appl. No.: 14/005,931

(22) PCT Filed: Mar. 23, 2012
(86) PCT No.: PCT/KR12/02142

§ 371 Date: Sep. 18, 2013

(30) Foreign Application Priority Data
Mar. 23, 2011 (KR) 10-2011-0026061

(51) Int. Cl. H04W 52/36

(52) U.S. Cl. CPC H04W 52/365
USPC 455/522

(57) ABSTRACT

The present invention provides an apparatus and method for performing a Power Headroom Report (PHR) in a wireless communication system. A mobile station includes a trigger prohibition unit for measuring a primary prohibition timer and a secondary prohibition timer used to prohibit the trigger of the PHR and for generating or prohibiting at least one of the trigger of a first PHR based on the amount of a change in Path Loss and the trigger of a second PHR based on the amount of a change in Power Backoff based on the state of the primary prohibition timer or the secondary prohibition timer and an uplink transmission unit for transmitting a Medium Access Control message, including the PHR, to a base station based on the trigger of the first PHR or the trigger of the second PHR.

### CROSS-REFERENCE TO RELATED APPLICATIONS

This application is the National Stage Entry of International Application PCT/KR2012/002142, filed on Mar. 23, 2012, and claims priority from and the benefit of Korean Patent Application No. 10-2011-0026061, filed on Mar. 23, 2011, both of which are incorporated herein by reference in their entireties for all purposes as if fully set forth herein.

### BACKGROUND

1. Field

The present invention relates to wireless communication and, more particularly, to an apparatus and method for performing a Power Headroom Report in a wireless communication system supporting a plurality of component carriers.

2. Discussion of the Background

One of methods in which a base station efficiently utilizes the resources of a mobile station is to use power headroom information about the mobile station. Power control technology is essential and core technology necessary to minimize interference factors and reduce the battery consumption of the mobile station for the efficient distribution of resources in wireless communication. When a mobile station provides power headroom information to a base station, the base station can estimate maximum transmission power in uplink that may be handled by the mobile station. The base station can provide the mobile station with uplink scheduling, such as Transmit Power Control (TPC), a Modulation and Coding Scheme (MCS), and a bandwidth, within a range of the estimated maximum transmission power.

If transmissions according to different communication schemes occur at the same time in a mobile station, power management is required because uplink power consumption is greater than that when only transmission according to any one communication scheme occurs. Power backoff for power management additionally reduces the maximum power of a mobile station in uplink. Accordingly, there is a need for a PHR according to the additional Maximum Power Reduction (MPR).

### SUMMARY

An object of the present invention is to provide an apparatus and method for performing a PHR in a wireless communication system.

Another object of the present invention is to provide an apparatus and method for performing a PHR in a wireless communication system supporting a plurality of component carriers.

Yet another object of the present invention is to provide an apparatus and method for triggering a PHR according to a change of power backoff in a wireless communication system.

Further yet another object of the present invention is to provide an apparatus and method for triggering a PHR by a plurality of prohibition timers in a wireless communication system.

In accordance with an aspect of the present invention, a mobile station performing a Power Headroom Report (PHR) includes a trigger prohibition unit for measuring the amount of a change in Path Loss (PL) for a serving cell configured in the mobile station, the amount of a change in Power Backoff (PB) for the mobile station, and a primary prohibition timer and a secondary prohibition timer used to prohibit the trigger of the PHR and for generating or prohibiting at least one of the trigger of a first PHR based on the amount of a change in PL and the trigger of a second PHR based on the amount of a change in PB based on the state of the primary prohibition timer or the secondary prohibition timer and an uplink transmission unit for transmitting a Medium Access Control (MAC) message, including the PHR, to a base station based on the trigger of the first PHR or the trigger of the second PHR.

In accordance with another aspect of the present invention, a method of a mobile station performing a PHR includes measuring the amount of a change in PL for a serving cell configured in the mobile station, the amount of a change in PB for the mobile station, and a primary prohibition timer and a secondary prohibition timer used to prohibit the trigger of the PHR; performing a control procedure of generating or prohibiting at least one of the trigger of a first PHR based on the amount of a change in PL and the trigger of a second PHR based on the amount of a change in PB based on the state of the primary prohibition timer and of generating or prohibiting the trigger of the second PHR based on the amount of a change in PB based on the state of the secondary prohibition timer; and transmitting an MAC message, including the PHR, to a base station.

In accordance with yet another aspect of the present invention, a base station receiving a PHR includes a Radio Resource Control (RRC) configuration unit for generating an RRC message including prohibition timer configuration information including information about the length of each of a primary prohibition timer and a secondary prohibition timer which are used to prohibit the trigger of the PHR; a scheduling unit for performing uplink scheduling for a mobile station and generating an uplink grant; a downlink transmission unit for transmitting the RRC message and the uplink grant to the mobile station; and an uplink reception unit for receiving the PHR from the mobile station through uplink resources based on the uplink grant.

In accordance with the present invention, since a cooperation operation between the trigger of a PHR by power backoff and the trigger of a PHR by path loss are clearly defined, uplink power control can be efficiently performed. Furthermore, overhead can be reduced because the number of PHRs transmitted is properly controlled.

### BRIEF DESCRIPTION OF THE DRAWINGS

FIG. 1 shows a wireless communication system to which the present invention is applied;

FIG. 2 is an explanatory diagram illustrating an intra-band contiguous carrier aggregation in the wireless communication system to which the present invention is applied;

FIG. 3 is an explanatory diagram illustrating an intra-band non-contiguous carrier aggregation in the wireless communication system to which the present invention is applied;

FIG. 4 is an explanatory diagram illustrating an inter-band carrier aggregation in the wireless communication system to which the present invention is applied;

FIG. 5 shows a linkage between a downlink component carrier and an uplink component carrier in the wireless communication system to which the present invention is applied;

FIG. 6 is a graph showing an example of power headroom to which the present invention is applied in the time-frequency axis;

FIG. 7 is a conceptual diagram showing the influence of the uplink scheduling of a BS on the transmission power of UE in a wireless communication system;

FIG. 8 is an explanatory diagram illustrating a power control amount and a maximum transmission power in a multiple component carrier system according to an example of the present invention;

FIG. 9 is an explanatory diagram illustrating a state in which power backoff generated by 1xRTT and path loss measured in an LTE receiver to which the present invention is applied are changed according to a lapse of time;

FIG. 10 is an explanatory diagram illustrating the trigger of a PHR according to an example of the present invention;

FIG. 11 is an explanatory diagram illustrating the trigger of a PHR according to another example of the present invention;

FIG. 12 is an explanatory diagram illustrating the trigger of a PHR according to yet another example of the present invention;

FIG. 13 is an explanatory diagram illustrating an embodiment in which a PHR is triggered by a plurality of prohibition timers according to the present invention;

FIG. 14 is an explanatory diagram illustrating another embodiment in which a PHR is triggered by a plurality of prohibition timers according to the present invention;

FIG. 15 is an explanatory diagram illustrating yet another embodiment in which a PHR is triggered by a plurality of prohibition timers according to the present invention;

FIG. 16 is a flowchart illustrating a method of a mobile station performing a PHR according to an example of the present invention;

FIG. 17 is a flowchart illustrating a method of a mobile station performing a PHR according to another example of the present invention;

FIG. 18 is a flowchart illustrating a method of a mobile station performing a PHR according to yet another example of the present invention;

FIG. 19 is a flowchart illustrating a method of a base station performing a PHR according to an example of the present invention; and

FIG. 20 is a block diagram of a mobile station and a base station which perform a PHR according to an example of the present invention.

### DETAILED DESCRIPTION OF THE ILLUSTRATED EMBODIMENTS

Some embodiments of the present invention will now be described in detail with reference to the accompanying drawings. It is to be noted that in assigning reference numerals to respective elements in the drawings, the same reference numerals designate the same elements although they are shown in different drawings. Furthermore, in describing the embodiments of the present invention, a detailed description of known constructions or functions will be omitted if it is deemed to make the gist of the present invention unnecessarily vague.

Furthermore, in describing the elements of this specification, terminologies, such as the first, the second, A, B, (a), and (b), may be used. The terminologies are used to only distinguish elements from one another, but the essence, sequence and the like of the elements are not limited by the terminologies. Furthermore, in the case where one element is described to be “connected”, “coupled”, or “linked” to the other element, the one element may be directly connected or coupled to the other element, but it is be understood that a third element may be “connected”, “coupled”, or “linked” between the elements.

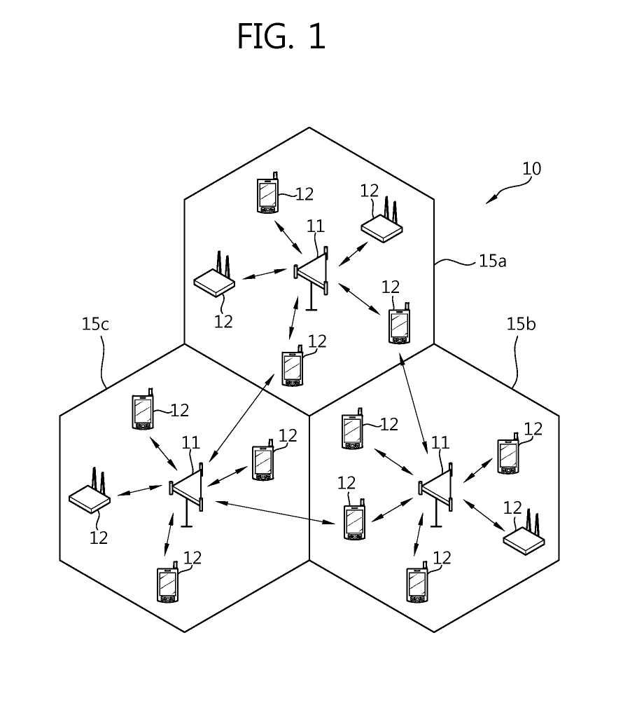

FIG. 1 shows a wireless communication system.

Referring to FIG. 1, the wireless communication systems 10 are widely deployed in order to provide a variety of communication services, such as voice and packet data.

The wireless communication system 10 includes one or more Base Stations (BS) 11. The BSs 11 provide communication services to specific geographical areas (typically called cells) 15a, 15b, and 15c. Each of the cells may be classified into a plurality of areas (called sectors).

A Mobile Stations (MS) 12 may be fixed or mobile and may also be called another terminology, such as User Equipment (UE), a Mobile Terminal (MT), a User Terminal (UT), a Subscriber Station (SS), a wireless device, a Personal Digital Assistant (PDA), a wireless modem, or a handheld device.

The BS 11 refers to a fixed station communicating with the MSs 12, and it may also be called another terminology, such as an evolved NodeB (eNB), a Base Transceiver System (BTS), or an access point. The cell should be interpreted as a comprehensive meaning indicating some area covered by the BS 11. The cell has a meaning to cover various coverage areas, such as a mega cell, a macro cell, a micro cell, a pico cell, and a femto cell.

Hereinafter, downlink refers to communication from the BS 11 to the MS 12, and uplink refers to communication from the MS 12 to the BS 11. In downlink, a transmitter may be part of the BS 11, and a receiver may be part of the MS 12. In uplink, a transmitter may be part of the MS 12, and a receiver may be part of the BS 11.

Multiple access schemes applied to the wireless communication system are not limited. A variety of multiple access schemes, such as Code Division Multiple Access (CDMA), Time Division Multiple Access (TDMA), Frequency Division Multiple Access (FDMA), Orthogonal Frequency Division Multiple Access (OFDMA), Single Carrier Frequency Division Multiple Access (SC-FDMA), OFDM-FDMA, OFDM-TDMA, and OFDM-CDMA, may be used. Uplink transmission and downlink transmission may be performed in accordance with a Time Division Duplex (TDD) scheme using different times or a Frequency Division Duplex (FDD) scheme using different frequencies.

The layers of a radio interface protocol between a mobile station and a network may be classified into a first layer L1, a second layer L2, and a third layer L3 which are three lower layers of an Open System Interconnection (OSI) that is widely known in communication systems.

A physical layer (i.e., the first layer) is connected to a higher Medium Access Control (MAC) layer through a transport channel. Data between the MAC layer and the physical layer is transported through the transport channel. Furthermore, data between different physical layers (i.e., the physical layer on the transmission side and the physical layer on the reception side) is transported through a physical channel. Some control channels are used in the physical layer.

A Physical Downlink Control Channel (PDCCH) through which physical control information is transmitted informs an MS of the resource allocation of a paging channel (PCH) and a downlink shared channel (DL-SCH) and Hybrid Automatic Repeat Request (HARQ) information related to the DL-SCH. The PDCCH may carry an uplink grant, informing an MS of the allocation of resources for uplink transmission. A Physical Control Format Indicator Channel (PCFICH) is used to inform an MS of the number of OFDM symbols used in PDCCHs and is transmitted for every subframe. A Physical Hybrid ARQ Indicator Channel (PHICH) carries an HARQ ACK/NAK signal in response to uplink transmission. A Physical Uplink Control Channel (PUCCH) carries HARQ ACK/NAK for downlink transmission, a scheduling request, and uplink control information, such as a Channel Quality Indicator (CQI). A Physical Uplink Shared Channel (PUSCH) carries an Uplink Shared channel (UL-SCH).

A situation in which an MS transmits the PUCCH or the PUSCH is described below.

An MS configures a PUCCH for one or more of Channel Quality Information (CQI), a Precoding Matrix Index (PMI) selected based on measured space channel information, and a Rank Indicator (RI) and periodically transmits the configured PUCCH to a BS. Furthermore, the MS must receive information about Acknowledgement/non-Acknowledgement (ACK/NACK) for downlink data from the BS and then transmit the information to the BS after a specific number of subframes. For example, if downlink data is received in an n^{th} subframe, the MS transmits a PUCCH, including ACK/NACK information about the downlink data, in an (n+4)^{th} subframe. If all pieces of ACK/NACK information cannot be transmitted on a PUCCH allocated by a BS or if a PUCCH on which ACK/NACK information can be transmitted is not allocated by a BS, an MS may carry the ACK/NACK information on a PUSCH.

A radio data link layer (i.e., the second layer) includes an MAC layer, a Radio Link Control (RLC) layer, and a Packet Data Convergence Protocol (PDCP) layer. The MAC layer is a layer responsible for mapping between a logical channel and a transport channel. The MAC layer selects a proper transport channel suitable for sending data received from the RLC layer and adds necessary control information to the header of an MAC Protocol Data Unit (PDU). The RLC layer is placed over the MAC layer and is configured to support reliable data transmission. Furthermore, the RLC layer segments and concatenates RLC Service Data Units (SDUs), received from a higher layer, in order to configure data having a size suitable for a radio section. The RLC layer of a receiver supports a data reassembly function for recovering original RLC SDUs from received RLC PDUs. The PDCP layer is used only in a packet exchange region. The PDCP layer may compress and transmit the header of an Internet Protocol (IP) packet in order to increase the transmission efficiency of packet data in a radio channel.

A Radio Resource Control (RRC) layer (i.e., the third layer) functions to control a lower layer and also to exchange pieces of radio resource control information between an MS and a network. A variety of RRC states, such as an idle mode and an RRC connected mode, are defined according to the communication state of an MS. The MS may be switched between the RRC states, if necessary. Various procedures related to the management of radio resources, such as system information broadcasting, an RRC access management procedure, a multiple component carrier configuration procedure, a radio bearer control procedure, a security procedure, a measurement procedure, and a mobility management procedure (handover), are defined in the RRC layer.

A carrier aggregation (CA) supports a plurality of component carriers. The carrier aggregation is also called a spectrum aggregation or a bandwidth aggregation. An individual unit carrier aggregated by the carrier aggregation is called a Component Carrier (CC). Each of the CCs is defined by a bandwidth and the center frequency. The carrier aggregation is introduced to support an increased throughput, prevent an increase of costs due to the introduction of wideband Radio Frequency (RF) devices, and guarantee compatibility with the existing system. For example, if five CCs are allocated as the granularity of a carrier unit having a 5 MHz bandwidth, a maximum bandwidth of 25 MHz can be supported.

CCs may be divided into a primary CC (hereinafter referred to as a PCC) and a secondary CC (hereinafter referred to as an SCC) according to whether they have been activated. The PCC is always being activated, and the SCC is activated or deactivated according to a specific condition. The term ‘activation’ means that the transmission or reception of traffic data is being performed or is in a standby state. The term ‘deactivation’ means that the transmission or reception of traffic data is impossible, but measurement or the transmission or reception of minimum information is possible. An MS may use only one PCC or one or more SCCs along with a PCC. A BS may allocate a PCC or an SCC or both to an MS.

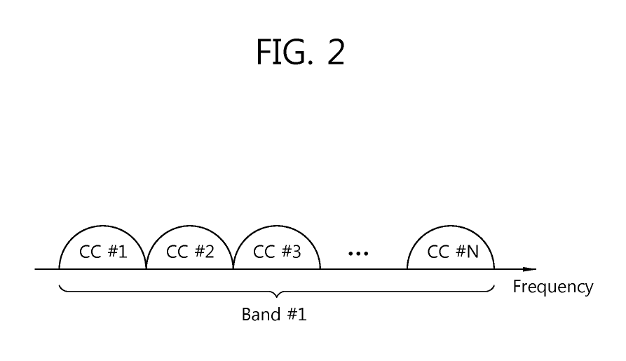

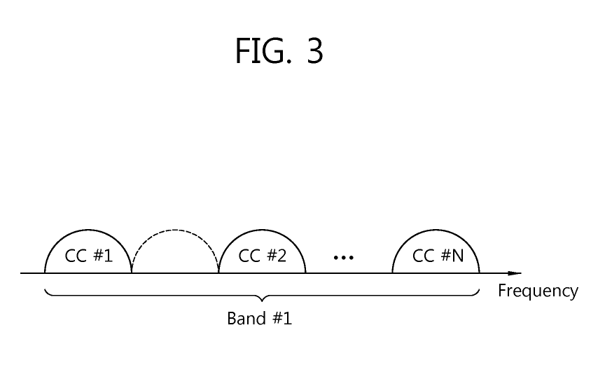

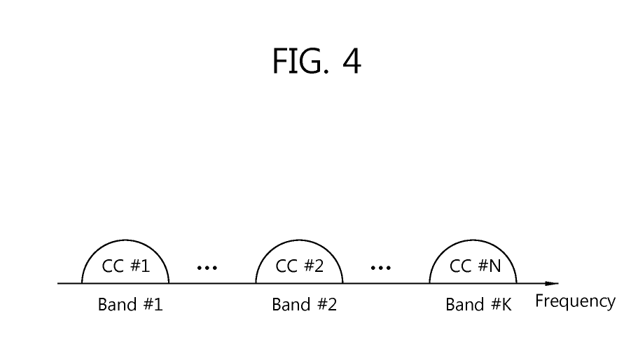

A carrier aggregation may be classified into an intra-band contiguous carrier aggregation, such as that shown in FIG. 2, an intra-band non-contiguous carrier aggregation, such as that shown in FIG. 3, and an inter-band carrier aggregation, such as that shown in FIG. 4.

Referring first to FIG. 2, the intra-band contiguous carrier aggregation is performed between CCs which are contiguous to each other within the same operation band. For example, all CC#1, CC#2, CC#3, . . . , CC #N (i.e., aggregated CCs) are contiguous to each other.

Referring to FIG. 3, the intra-band non-contiguous carrier aggregation is performed between discontinuous CCs. For example, CC#1 and CC#2 (i.e., aggregated CCs) are spaced apart from each other at a specific frequency.

Referring to FIG. 4, in the inter-band carrier aggregation, one or more of a plurality of CCs are aggregated on different frequency bands. For example, a CC #1 (i.e., an aggregated CC) exists in an operation band #1 and a CC #2 (i.e., an aggregated CC) exists in an operation band #2.

The number of aggregated downlink CCs and the number of aggregated uplink CCs may be differently set. When the number of downlink CCs is identical to the number of uplink CCs, it is called a symmetric aggregation. When the number of downlink CCs is different from the number of uplink CCs, it is called an asymmetrical aggregation.

Furthermore, CCs may have different sizes (i.e., bandwidths). For example, assuming that 5 CCs are used to form a 70 MHz band, a resulting configuration may be, for example, 5 MHz CC (carrier #0)+20 MHz CC (carrier #1)+20 MHz CC (carrier #2)+20 MHz CC (carrier #3)+5 MHz CC (carrier #4).

Hereinafter, the term ‘multiple carrier system’ refers to a system supporting the carrier aggregation. In the multiple carrier system, a contiguous carrier aggregation or a non-contiguous carrier aggregation or both may be used. Furthermore, either a symmetrical aggregation or an asymmetrical aggregation may be used.

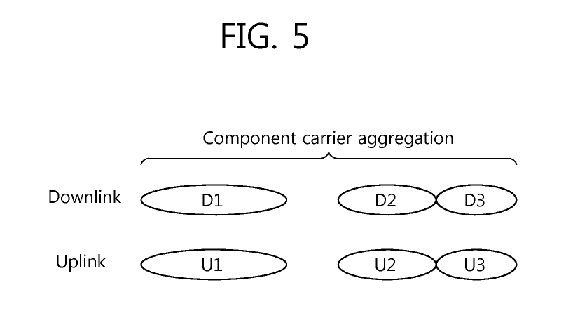

FIG. 5 shows a linkage between a downlink component carrier and an uplink component carrier in a multiple carrier system.

Referring to FIG. 5, in downlink, Downlink CCs (hereinafter referred to as ‘DL CCs’) D1, D2, and D3 are aggregated. In uplink, Uplink CCs (hereinafter referred to as ‘UL CCs’) U1, U2, and U3 are aggregated. Here, Di is the index of a DL CC, and Ui is the index of a UL CC (where i=1, 2, 3). At least one DL CC is a PCC, and the remaining CCs are SCCs. Likewise, at least one UL CC is a PCC, and the remaining CCs are SCCs. For example, D1 and U1 may be PCCs, and D2, U2, D3, and U3 may be SCCs.

In an FDD system, a DL CC and a UL CC are linked to each other in a one-to-one manner. Each of pairs of the D1 and U1, the D2 and U2, and the D3 and U3 is linked to each other in a one-to-one manner. An MS sets up pieces of linkage between the DL CCs and the UL CCs on the basis of system information transmitted on a logical channel BCCH or a UE-dedicated RRC message transmitted on a DCCH. Each of the pieces of linkage may be set up in a cell-specific way or a UE-specific way.

Only the 1:1 linkage between the DL CC and the UL CC has been illustrated in FIG. 5, but a 1:n or n:1 linkage may also be set up. Furthermore, the index of a component carrier does not comply with the sequence of the component carrier or the position of the frequency band of the component carrier.

Power headroom (PH) is described below.

Power headroom refers to surplus power that may be additionally used by an MS in addition to power now being used for uplink transmission. For example, it is assumed that an MS has a maximum transmission power of 10 W (i.e., a permitted uplink transmission power). It is also assumed that the MS now uses power of 9 W in a frequency band of 10 MHz. In this case, power headroom is 1 W because the MS can further use power of 1 W.

If a BS allocates a frequency band of 20 MHz to the MS, power of 9 W×2=18 W is required. If the frequency band of 20 MHz is allocated to the MS, however, the MS may not use the entire frequency band or the BS may not properly receive a signal from the MS owing to the shortage of power because the MS has the maximum power of 10 W. In order to solve the problems, the MS may report that the power headroom is 1 W to the BS so that the BS can perform scheduling within the range of the power headroom. This report is called a Power Headroom Report (hereinafter referred to as a PHR).

Reported power headroom may be given as in the following table.

TABLE 1

| REPORTED VALUE | MEASURED QUANTITY VALUE (DB) |
|---|---|
| POWER_HEADROOM_0 | −23 ≦ PH < −22 |
| POWER_HEADROOM_1 | −22 ≦ PH < −21 |
| POWER_HEADROOM_2 | −21 ≦ PH < −20 |
| POWER_HEADROOM_3 | −20 ≦ PH < −19 |
| POWER_HEADROOM_4 | −19 ≦ PH < −18 |
| POWER_HEADROOM_5 | −18 ≦ PH < −17 |
| . . . | . . . |
| POWER_HEADROOM_57 | 34 ≦ PH < 35 |
| POWER_HEADROOM_58 | 35 ≦ PH < 36 |
| POWER_HEADROOM_59 | 36 ≦ PH < 37 |
| POWER_HEADROOM_60 | 37 ≦ PH < 38 |
| POWER_HEADROOM_61 | 38 ≦ PH < 39 |
| POWER_HEADROOM_62 | 39 ≦ PH < 40 |
| POWER_HEADROOM_63 | PH ≧ 40 |

Referring to Table 1, the power headroom falls within a range of −23 dB to +40 dB. If 6 bits are used to represent the power headroom, the power headroom is classified into a total of 64 levels because 2⁶=64 types of indices can be represented. For example, if a bit to represent power headroom is 0 (i.e., “000000” when represented by 6 bits), it indicates that the power headroom is −23 dB≦PPH≦−22 dB.

A periodic PHR method may be used because power headroom is frequently changed. In accordance with the periodic PHR method, when a periodic timer expires, an MS triggers a PHR. After reporting power headroom, the MS drives the periodic timer again.

If a Path Loss (hereinafter referred to as PL) estimate measured by an MS exceeds a certain reference value, a PHR may be triggered. The PL estimate is measured by an MS on the basis of Reference Symbol Received Power (RSRP).

The Power Headroom reporting procedure is used to provide the serving BS with information about the difference between the nominal UE maximum transmit power and the estimated power for UL-SCH transmission per activated Serving Cell and also with information about the difference between the nominal UE maximum power and the estimated power for UL-SCH and PUCCH transmission on Primary Cell.

Power headroom is defined as a difference between a maximum transmission power P_{CMAX}, configured in an MS, and estimate power P_{estimated} for uplink transmission, as in Equation 1. Power headroom is represented by dB.

MathFigure 1

P_{PH}=P_{CMAX}−P_{estimated} [dB] [Math. 1]

The power headroom P_{PH} may also be called the remaining power or surplus power. That is, the remainder obtained after the estimated power P_{estimated} (i.e., the sum of transmission powers being used by CCs) is subtracted from the maximum transmission power P_{CMAX} of an MS configured by a BS is the power headroom P_{PH}.

For example, the estimated power P_{estimated} is equal to power P_{PUSCH} estimated regarding the transmission of a Physical Uplink Shared Channel (PUSCH). Accordingly, the power headroom P_{PH} may be calculated using Equation 2.

MathFigure 2

P_{PH}=P_{CMAX}−P_{PUSCH} [dB] [Math. 2]

For another example, the estimated power P_{estimated} is equal to the sum of the power P_{PUSCH} estimated regarding the transmission of a PUSCH and power P_{PUCCH} estimated regarding the transmission of a Physical Uplink Control Channel (PUCCH). Accordingly, the power headroom P_{PH} may be calculated using Equation 3.

MathFigure 3

P_{PH}=P_{CMAX}−P_{PUCCH}−P_{PUSCH} [dB] [Math. 3]

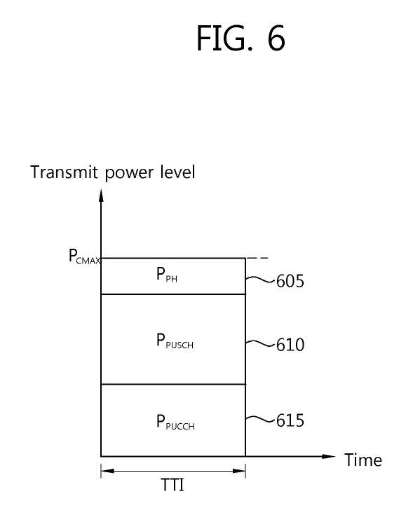

If the power headroom according to Equation 3 is represented by a graph in the time-frequency axis, it results in FIG. 6. FIG. 6 shows power headroom for one CC.

Referring to FIG. 6, a maximum transmission power P_{CMAX} configured in an MS includes P_{PH} 605, P_{PUSCH} 610, and P_{PUCCH} 615. In other words, the remaining power obtained after the P_{PUSCH} 610 and P_{PUCCH} 615 are subtracted from the maximum transmission power P_{CMAX} is the P_{PH} 605. Each power is calculated for every Transmission Time Interval (TTI).

A Primary Serving Cell (PCell) is a serving cell having a UL PCC on which a PUCCH can be transmitted. In a Secondary Serving Cell (SCell), power headroom is defined as in Equation 2 because a PUCCH cannot be transmitted, and parameters and an operation for a method of reporting power headroom defined by Equation 3 are not defined.

Meanwhile, in a PSC, an operation and parameters for a method of reporting power headroom defined by Equation 3 may be defined. If an MS has to receive an uplink grant from a BS, transmit a PUSCH in a PSC, and simultaneously transmit the PUCCH in the same subframe according to a predetermined rule, the MS calculates both the power headroom according to Equation 2 and the power headroom according to Equation 3 when a PHR is triggered and transmits the calculated power headroom to a BS.

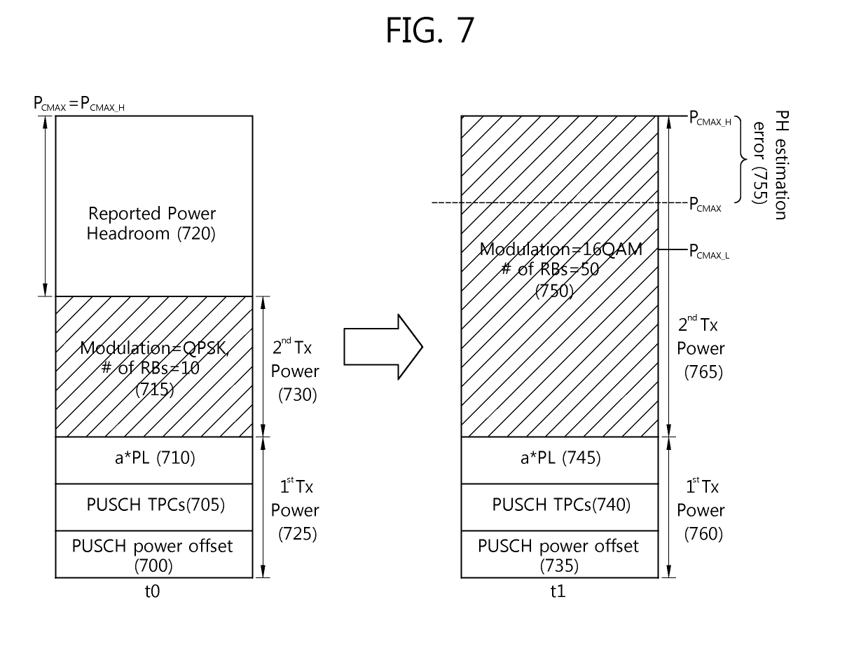

In a multiple component carrier system, power headroom may be defined for each of a plurality of configured CCs. This may be represented by a graph in the time-frequency axis as shown in FIG. 7.

Either in a single component carrier system or a multiple component carrier system, a maximum transmission power configured in an MS is influenced by a Maximum Power Reduction (hereinafter referred to as an MPR) of the MS. The MPR means that a maximum transmission power configured in an MS is reduced within a permitted range. The amount of power reduced by the MPR is called an MPR amount.

FIG. 7 is a conceptual diagram showing the influence of the uplink scheduling of a BS on the transmission power of an MS in a wireless communication system.

Referring to FIG. 7, the MS receives an uplink grant, permitting uplink data transmission, from the BS through a PDCCH at a time (or a subframe) t0. Accordingly, the MS has to calculate the amount of transmission power according to the uplink grant at the time t0.

At the time t0, the MS first calculates a primary transmission power (1^{st} Tx Power) 725 with consideration taken of a PUSCH power offset (700) value and a Transmission Power Control (TPC, 705) values received from the BS, an ‘a’ value (received from the BS) and PL 710 between the BS and the MS. The 1^{st} Tx power 725 is chiefly due to parameters influenced by a path environment between the BS and the MS and parameters determined by the policy of a network. In addition, the MS calculates a secondary transmission power (2^{nd} Tx power) 730 with consideration taken of a Quadrature Phase Shift Keying (QPSK) modulation scheme included in the uplink grant and a scheduling parameter 715 indicating the allocation of 10 Resource Block (RB). The 2^{nd} Tx power 730 is transmission power that is changed by the uplink scheduling of the BS.

Accordingly, the MS may calculate the final uplink transmission power by adding the 1^{st} Tx power 725 and the 2^{nd} Tx power 730. The final uplink transmission power cannot exceed the maximum transmission power P_{CMAX} configured in the MS. In the example of FIG. 7, uplink information transmission comparable to set parameters is possible because the final transmission power is smaller than the maximum transmission power P_{CMAX} at the time t0. Furthermore, power headroom 720 (i.e., a surplus amount for transmission power that may be additionally configured) exists. The MS transmits the power headroom 720 to the BS according to a rule defined in a wireless communication system.

At a time t1, the BS may change the QPSK modulation scheme and the scheduling parameter 715 into a 16QAM modulation scheme and a scheduling parameter 750 indicating the allocation of 50 resource blocks with consideration taken of transmission power that may be additionally configured in the MS based on the information of the power headroom 720. The MS reconfigures a 2^{nd} Tx power 765 based on the scheduling parameter 750. A 1^{st} Tx power 760 at the time t1 is calculated by taking a PUSCH power offset (735) value, TPC (740) values, and an ‘a’ value (received from the BS)*PL 745 between the BS and the MS into consideration. It is assumed that the 1^{st} Tx power 760 is equal to the 1st Tx power 725 at the time t0.

At the time t1, the maximum transmission power P_{CMAX} is changed into a value close to P_{CMAX}_{_{—}}_{L}, but the sum of the 2^{nd} Tx power 765 and the 1^{st} Tx power 760 necessary for the scheduling parameter 750 exceeds the maximum transmission power P_{CMAX}. In other words, there exists a power headroom estimated value error 755 equal to P_{CMAX}_{_{—}}_{H}−P_{CMAX′}. If scheduling for uplink resources is performed based on only power headroom information as described above, performance deterioration occurs because the MS cannot configure uplink transmission power expected by the BS. If a component carrier aggregation method is used, the power headroom estimated value error 755 is further increased. Accordingly, the MS has to reduce the maximum transmission power configured therein.

A range of the maximum transmission power of the MS into which an MPR is incorporated may be given as in the following Equation.

MathFigure 4

P_{CMAX}_{_{—}}_{L}≦P_{CMAX}≦P_{CMAX}_{_{—}}_{H} [Math. 4]

Here, P_{CMAX} is the maximum transmission power configured in the MS, P_{CMAX}_{_{—}}_{L} is a minimum value of P_{CMAX}, and P_{CMAX}_{_{—}}_{H} is a maximum value of P_{CMAX}. More specifically, P_{CMAX}_{_{—}}_{L} and P_{CMAX}_{_{—}}_{H} are calculated by Equation below.

MathFigure 5

P_{CMAX}_{_{—}}_{L}=MIN[P_{EMAX}−ΔT_{C},P_{powerclass}−MPR−AMPR−ΔT_{C}] [Math. 5]

MathFigure 6

P_{CMAX}_{_{—}}_{H}=MIN[P_{EMAX}−P_{powerclass}] [Math. 6]

In Equations 5 and 6, MIN[0] is a smaller value of ‘a’ and ‘b’, P_{EMAX} is a maximum power determined by the RRC signaling of the BS, and ΔT_{C} is the amount of power applied when there is uplink transmission at the edge of a band ΔT_{C} has 1.5 dB or 0 dB according to a bandwidth. P_{powerclass} is a power value according several power classes that have been defined in a system in order to support various specifications of MSs. In general, an LTE system supports a power class 3. P_{powerclass} according to the power class 3 is 23 dBm. The MPR is an MPR amount, and AMPR (i.e., Additional MPR) is an AMPR amount signalized by the BS.

The MPR may be set to a specific range or a specific constant. The MPR may be defined by the MS or by the CC and may be set to a specific range or constant for every CC. In an alternative, the MPR may be set to a specific range or constant according to whether the resource allocation of a PUSCH to each CC is contiguous or non-contiguous. In another alternative, the MPR may be set to a specific range or constant according to whether a PUCCH exists.

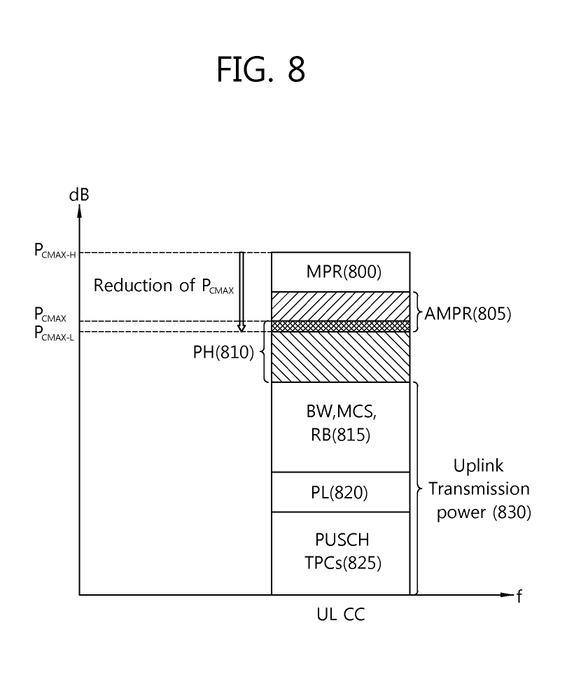

FIG. 8 is an explanatory diagram illustrating an MPR amount and a maximum transmission power in a multiple component carrier system according to an example of the present invention. For convenience of description, it is assumed that only one UL CC has been allocated to an MS.

Referring to FIG. 8, assuming that ΔT_{C}=0, a maximum value P_{CMAX}_{_{—}}_{H} of the maximum transmission power P_{CMAX} may be 23 dBm corresponding to a power class 3. A minimum value P_{CMAX}_{_{—}}_{L} of the maximum transmission power P_{CMAX} is obtained by subtracting an MPR amount 800 and an AMPR amount 805 from the maximum value P_{CMAX}_{_{—}}_{H}. That is, the MS reduces the minimum value P_{CMAX}_{_{—}}_{L} of the maximum transmission power P_{CMAX} by using the MPR amount 800 and the AMPR amount 805. The maximum transmission power P_{CMAX} is determined between the maximum value P_{CMAX}_{_{—}}_{H} and the minimum value P_{CMAX}_{_{—}}_{L}.

Meanwhile, an uplink transmission power 830 is the sum of power 815 determined by a bandwidth (BW), an MCS, and an RB, PL 820, and PUSCH TPCs 825. PH 810 is obtained by subtracting the uplink transmission power 830 from the maximum transmission power P_{CMAX}.

Only the one UL CC has been illustrated in FIG. 8. If a number of UL CCs are allocated, the maximum transmission power may be given by the MS not by the UL CC. The maximum transmission power by the MS may be given as the sum of maximum transmission powers for respective UL CCs.

In calculating the maximum transmission power, the P_{EMAX}, the ΔT_{C}, the P_{powerclass}, and the AMPR amount are already known to the BS or may be known to the BS. However, the BS cannot precisely know the maximum transmission power according to the MPR amount because it does not know the MPR amount. However, when the MS reports power headroom to the BS, the BS may approximately estimate the maximum transmission power based on the power headroom. The BS performs uncertain uplink scheduling within the estimated maximum transmission power. For this reason, when the worst, the BS may schedule modulation/channel bandwidth/RB that require transmission power greater than the maximum transmission power for the MS.

As described above, the PHR procedure is used to provide a serving BS with information about a difference between an estimated power for uplink data transmission for each activated serving cell and the nominal maximum transmission power of an MS. The PHR procedure is also used to provide information about a difference between an estimated power for uplink data transmission and PUCCH transmission for a primary serving cell and the nominal maximum transmission power of an MS.

If a PHR is sought to be triggered, a trigger condition must be satisfied. The trigger condition is also called an event. Parameters related to the trigger condition include the amount of a change in pass loss (PL), the amount of a change in power backoff (PB), and various timers. The parameters are associated with each other to define the trigger condition, or the parameters independently define the trigger condition.

1. Power Backoff (PB)

The PB refers to an MPR additionally generated by power management in uplink. Simultaneous transmissions according to different communication bases in an MS require power management because they have greater uplink power consumption than only one transmission according to any one communication base. Examples in which power management is required may include simultaneous transmissions according to a packet switching method and a circuit switching method, simultaneous transmission of non-voice data and voice data, simultaneous transmission of LTE-based data and 1x-EVDO (1xRTT)-based data, and an example in which a Specific Absorption Rate (SAR) is taken into consideration. The PB is also called a PMPR.

The PB is a parameter to determine a maximum transmission power P_{CMAX} configured in an MS.

For example, when the PB is taken into consideration, Equation 5 may be modified into Equation 7.

MathFigure 7

P_{CMAX}_{_{—}}_{L}=MIN[P_{EMAX}−ΔT_{C},P_{powerclass}−MAX[MPR+AMPR,PMPR]−ΔT_{C}] [Math. 7]

Referring to Equation 7, PMPR is a PB value. P_{CMAX}_{_{—}}_{L} is determined by any one greater value of MPR+AMPR and PMPR. That is, MPR+AMPR and PMPR are incompatible with each other, and MPR can be independently performed by only PMPR. For example, in Equation 7, if PMPR>MPR+AMPR, PMPR in itself is considered to be equal to MPR in Equation 5.

For another example, if the PB is taken into consideration, Equation 5 may be modified into Equation 8.

MathFigure 8

P_{CMAX}_{_{—}}_{L}=MIN[P_{EMAX}−ΔT_{C},P_{powerclass}−MPR−AMPR−PMPR−ΔT_{C}]

In Equation 8, P_{CMAX}_{_{—}}_{L} is calculated by using all MPR, AMPR, and PMPR. That is, MPR, AMPR, and PMPR are compatible with each other, and they influence P_{CMAX}_{_{—}}_{L}. In Equation 8, PMPR is an additional MPR generated by power management, and the PMPR differs from the pure MPR defined in Equation 5.

When comparing the definition of the PMPR value according to Equation 7 with the definition of the PMPR value according to Equation 8, the PMPR of Equation 7 refers to a PB value generated by 1xRTT, and the PMPR of Equation 8 is defined as a difference between the PB value generated by 1xRTT and the pure MPR value defined in Equation 5, which is obtained through comparison.

For example, assuming that the pure MPR value defined in Equation 5 is 8 dB and a PB value estimated by 1xRTT is 7 dB, the PMPR value defined in Equation 7 may become 7 dB and the PMPR value defined in Equation 8 becomes 0 dB. The PMPR value defined in Equation 8 becomes 0 dB because there is no influence if the PMPR value is a smaller value.

For another example, assuming that the pure MPR value is 8 dB and a PB value estimated by 1xRTT is 10 dB, the PMPR value defined in Equation 7 may become 10 dB and the PMPR value defined in Equation 8 becomes 2 dB (=10 dB-8 dB).

As described in Equation 7 and Equation 8, the maximum transmission power P_{CMAX} is changed by the PB. When the maximum transmission power P_{CMAX} is changed, power headroom is also changed. That is, the PB influences a change of the power headroom, and the amount of a change in PB is used to define the trigger condition along with the amount of a change in PL. That is, the triggering of a PHR may be generated on the basis of the PB or the PL. For example, the trigger condition may include that the amount of a change in PB is greater than a PB critical value. For another example, the trigger condition may include that the amount of a change in PL is greater than a PL critical value.

The PB and the PL have a difference in terms of their characteristics.

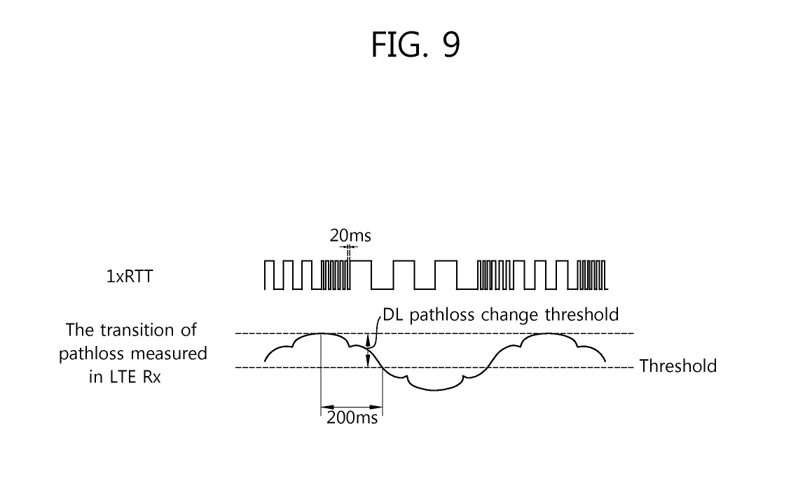

FIG. 9 is an explanatory diagram illustrating a state in which PB generated by 1xRTT is applied and PL measured in an LTE receiver are changed according to a lapse of time.

1xRTT refers to a circuit-based communication system and includes CDMA 2000 communication, WCDMA communication, etc. That is, 1xRTT may include other communication systems different from an LTE system.

Referring to FIG. 9, PB by 1xRTT is generated irrespective of a change in the channel. Furthermore, PL is slowly changed per 200 ms, but a change of the PB generated by 1xRTT is relatively sharply changed per 20 ms.

Meanwhile, an MPR is generated by an MS according to a method of allocating resources in an LTE uplink grant or a modulation scheme. Accordingly, the same MPR may be applied to uplink grants having the same resource allocation method or modulation scheme. However, the PB generated by 1xRTT is generated separately from the LTE uplink grant and is sharply generated according to whether 1xRTT data transmission and LTE transmission are generated at the same time.

If the maximum transmission power P_{CMAX} is changed by the PB as described above, the power headroom is also changed. Since a change of the power headroom due to the PB is sharp, if a PHR is transmitted whenever the power headroom is changed, overhead may occur owing to the frequent transmission. In addition, overhead may be further increased because the PHR may be generated by not only the PB, but also other causes, such as PL. Accordingly, in order to efficiently perform uplink power control, there is a need for a method of properly triggering the PHR according to a change of the PB. To this end, a trigger condition different from the trigger condition defined on the basis of the PL must be defined. Furthermore, a procedure for an operation when the trigger condition based on the PL is operated in conjunction with the trigger condition different from the trigger condition defined on the basis of the PL needs to be clearly defined.

2. Timer

The timer is one of elements that define a trigger condition and controls the trigger of a PHR along with the amount of a change in PL and the amount of a change in PB. The timer includes a periodic PHR timer (hereinafter referred to as a periodic timer) and a prohibition PHR timer (hereinafter referred to as a prohibition timer). The periodic timer controls a PHR so that the PHR can be periodically triggered. Furthermore, the prohibition timer prohibits the trigger of a PHR.

The periodic timer may be started or restarted when uplink resources for new transmission are allocated to an MS at the present Transmission Time Interval (TTI) or when allocated uplink resources can accommodate a PHR MAC Control Element (CE) including a subheader as a result of a logical channel priority. In an alternative, the periodic timer may be restarted when the trigger of a PHR based on any one of PL and PB is generated. The periodic timer expires after a lapse of predetermined time since it is started or restarted.

The value of each of the periodic timer and the prohibition timer may be represented by the number of subframes. For example, if the value of the periodic timer is 10, it may correspond to 10 subframes. In this case, the PHR of an MS is triggered every 10 subframes. If the value of the prohibition timer is 10, the trigger of a PHR is prohibited during 10 subframes. When the prohibition timer expires after the 10 subframe, there is a chance that the PHR is triggered.

The setting of the periodic timer and the prohibition timer may be controlled by an RRC layer. For example, a BS may transmit an RRC message, such as an information element MAC-MainConfig shown in Table 2, to an MS. Table 2 shows an example in which the number of prohibition timers is two.

TABLE 2

| | |
|---|---|
| MAC-MainConfig ::= | SEQUENCE { |

| . | |
|---|---|
| . | |
| . | |
| phr-Config | CHOICE { |
| release | NULL, |
| setup | SEQUENCE { |

| | |
|---|---|
| periodicPHR-Timer | ENUMERATED {sf10, sf20, sf50, sf100, sf200, |

sf500, sf1000, infinity},

| | |
|---|---|
| primary prohibitPHR-Timer | ENUMERATED {sf0, sf10, sf20, sf50, sf100, |

sf200, sf500, sf1000},

secondary prohibitPHR-Timer ENUMERATED {sf0, sf30, sf60, sf100, sf150,

sf200, sf500, sf1000},

| | |
|---|---|
| dl-PathlossChange | ENUMERATED {dB1, dB3, dB6, infinity) |

}

| | |
|---|---|
| } | OPTIONAL, -- Need ON |

.
.
.

}

Referring to Table 2, the RRC message includes a periodic timer (periodicPHR-Timer) value and a prohibition timer (prohibitPHR-Timer) value. There are two types of the prohibition timer; a primary prohibition timer and a secondary prohibition timer. The value ‘sfn’ of the prohibition timer means that the prohibition timer is operated during ‘n’ subframes.

The primary prohibition timer can prohibit the triggers of PHRs based on all causes. For example, the primary prohibition timer prohibits not only the trigger of a PHR based on PB, but also the trigger of a PHR based on PL. Meanwhile, the secondary prohibition timer prohibits only the trigger of a PHR based on some causes. For example, the secondary prohibition timer may prohibit only the trigger of a PHR based on PB, but do not prohibit the trigger of a PHR based on PL.

Accordingly, if the primary prohibition timer expires, but the secondary prohibition timer does not expire, the PHR based on the PB is not triggered, but the PHR based on the PL may be triggered. If the primary prohibition timer does not expire, but only the secondary prohibition timer expires, the PHRs based on all the causes are triggered. In this case, the trigger of the PHR based on the PB may be performed only when both the primary prohibition timer and the secondary prohibition timer expire.

Point of times at which the primary prohibition timer and the secondary prohibition timer are restarted may differ after the primary prohibition timer and the secondary prohibition timer expire.

For example, when a PHR based on any cause is transmitted, the primary prohibition timer and the secondary prohibition timer are restarted. For example, the transmission of a PHR based on PL restarts not only the primary prohibition timer, but also the secondary prohibition timer. Furthermore, the transmission of a PHR based on PB restarts not only the secondary prohibition timer, but also the primary prohibition timer.

For another example, a prohibition timer that is restarted may differ according to a cause in which a PHR is transmitted. For example, the transmission of a PHR based on PL restarts both the primary prohibition timer and the secondary prohibition timer. Meanwhile, the transmission of a PHR based on PB restarts only the secondary prohibition timer, but does not restart the primary prohibition timer.

For yet another example, a PHR based on a specific cause may restart a specific prohibition timer. For example, the transmission of a PHR based on PL may restart only the primary prohibition timer, and the transmission of a PHR based on PB may restart only the secondary prohibition timer.

The types of the prohibition timer have been illustrated to be two in Table 2, but they are only illustrative. The types of the prohibition timer may be 3 or more. In this case, two of the three prohibition timers may be prohibited by the remaining one prohibition timer.

For another example, a BS may transmit an RRC message, such as an information element MAC-MainConfig in Table 3, to an MS. Table 3 shows an example in which the number of prohibition timers is one.

TABLE 3

| | |
|---|---|
| MAC-MainConfig ::= | SEQUENCE { |

| . | |
|---|---|
| . | |
| . | |
| phr-Config | CHOICE { |
| release | NULL, |

| | |
|---|---|
| setup | SEQUENCE { |

| | |
|---|---|
| periodicPHR-Timer | ENUMERATED {sf10, sf20, sf50, sf100, sf200, |

sf500, sf1000, infinity},

| | |
|---|---|
| prohibitPHR-Timer | ENUMERATED (sf0, sf10, sf20, sf50, sf100, |

sf200, sf500, sf1000},

| | |
|---|---|
| d1-PathlossChange | ENUMERATED {dB1, dB3, dB6, infinity} |

}

| | |
|---|---|
| } | OPTIONAL, -- Need ON |

.
.
.

]

Referring to Table 3, the RRC message includes a periodic timer value and a prohibition timer value. The number of prohibition timers is one, and the prohibition timer may prohibit the triggers of PHRs based on all causes. That is, the prohibition timer prohibits both the trigger of a PHR based on PB and the trigger of a PHR based on PB. The prohibition timer expires after n subframes according to ‘sfn’. When a PHR based on any cause is transmitted, the prohibition timer is restarted.

3. Trigger of a PHR

The PHR is triggered when the trigger condition is satisfied. Elements that define the trigger condition, as described above, include the amount of a change in PB, the amount of a change in PL, and the timer. The elements are associated with each other, thus defining the trigger condition. If a PHR is sought to be triggered, it is basically required that the amount of a change in PB be greater than a critical value or the amount of a change in PL is greater than the critical value and the prohibition timer expire. The trigger condition that triggers a PHR is described below. Furthermore, examples in which the number of prohibition timers is 1 as in Table 3 and the number of prohibition timers is plural as in Table 2 are described.

(1) When the Number of Prohibition Timers is 1

For example, a PHR may be triggered when a periodic timer expires.

For another example, a PHR may be triggered when a prohibition timer expires and the amount of a change in PL is greater than a PL critical value.

For yet another example, a PHR may be triggered when a prohibition timer expires and the amount of a change in PB is greater than a PB critical value.

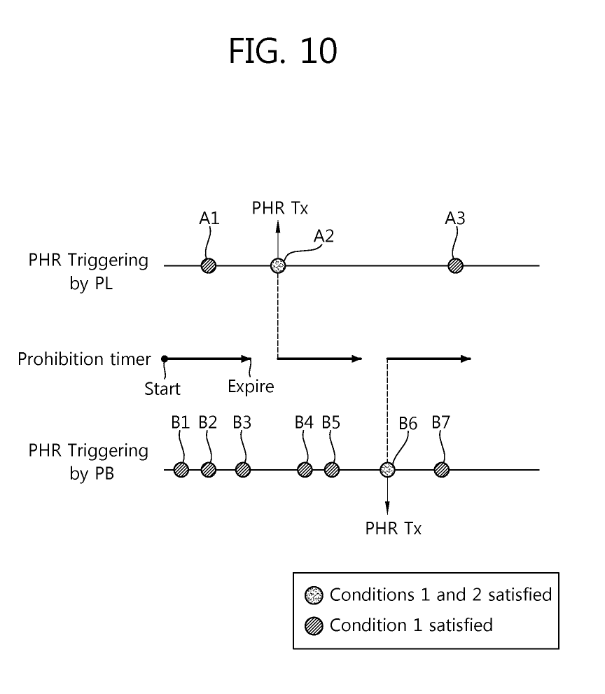

FIG. 10 is an explanatory diagram illustrating the trigger of a PHR according to an example of the present invention. FIG. 10 shows an example in which the number of prohibition timers is 1.

Referring to FIG. 10, PHR triggering by PL and PHR triggering by PB are controlled by one prohibition timer. In view of the flow of time, points of time B1 to B7 at which the amount of a change in PB is greater than a PB critical value are more frequently generated than points of time A1, A2, and A3 at which the amount of a change in PL is greater than a PL critical value.

If a PHR is sought to be triggered, two types of the trigger condition must be satisfied. First, if the amount of a change in PL is greater than a PL critical value or the amount of a change in PB is greater than a PB critical value, a condition 1 on PHR triggering is satisfied. Furthermore, when the prohibition timer expires, a condition 2 on PHR triggering is satisfied. If both the condition 1 and the condition 2 are satisfied, a PHR is triggered and the PHR is transmitted.

At the point of time A1, the condition 1 is satisfied because the amount of a change in PL is greater than the PL critical value, but the condition 2 is not satisfied because the prohibition timer has not yet expired Likewise, at the points of time B1, B2, and B3, the condition 1 is satisfied because the amount of a change in PB is greater than a PB critical value, but the condition 2 is not satisfied because the prohibition timer has not yet expired. Accordingly, at the points of time A1, B1, B2, and B3, a PHR is not triggered.

Next, at the point of time A2, a PHR is triggered and transmitted (i.e., PHR Tx) because both the condition 1 and the condition 2 are satisfied. Since the transmission of the PHR has been generated, the prohibition timer is restarted at the point of time A2. At the points of time B4 and B5 before the prohibition timer expires after it has been restarted, a PHR is not triggered because the condition 1 is satisfied, but the condition 2 is not satisfied.

At the point of time B6, a PHR is triggered and transmitted because both the condition 1 and the condition 2 are satisfied. Since the transmission of the PHR has been generated, the prohibition timer is restarted at the point of time B6.

If, as described above, one prohibition timer controls the triggers of PHRs due to several causes at once, overhead due to frequent PHRs can be reduced and a PHR triggering procedure can become clear. An example in which the trigger of a PHR and the transmission of the PHR are generated at the same time has been described in FIG. 10, for convenience sake, but the example is only illustrative. For example, the trigger of a PHR and the transmission of the PHR may be generated at different points of time.

(2) When the Number of Prohibition Timers is Plural

The number of prohibition timers may be plural as in Table 2. A technical spirit regarding an operation in which two prohibition timers (i.e., a primary prohibition timer and a secondary prohibition timer) are operated in conjunction with each other to prohibit the trigger of a PHR may also be applied to a case in which three or more prohibition timers exist.

For example, a PHR may be triggered when a periodic timer expires.

For another example, a PHR may be triggered when the primary prohibition timer expires and the amount of a change in PL is greater than a PL critical value.

For yet another example, a PHR may be triggered when the primary prohibition timer expires and the secondary prohibition timer expires.

The primary prohibition timer and the secondary prohibition timer may have the same value or different values. If the primary prohibition timer and the secondary prohibition timer have different values, the value of the primary prohibition timer may be greater than or smaller than the value of the secondary prohibition timer.

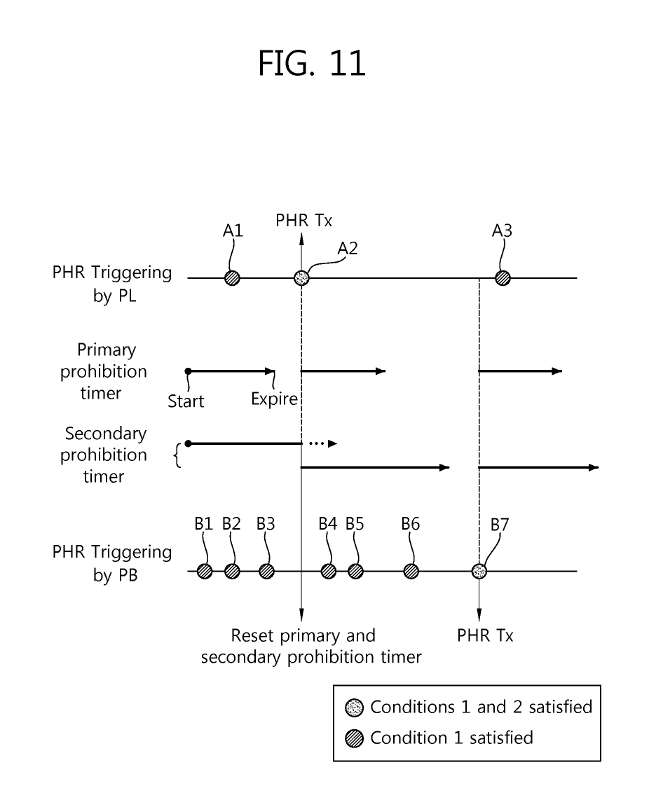

FIG. 11 is an explanatory diagram illustrating the trigger of a PHR according to another example of the present invention. FIG. 11 corresponds to an example in which the number of prohibition timers is two and points of time at which the primary prohibition timer and the secondary prohibition timer are restarted are reset or restarted by the transmission of a PHR.

Referring to FIG. 11, PHR triggering by PL and PHR triggering by PB are controlled by the two prohibition timers. If the PHR is sought to be triggered, two types of trigger conditions must be satisfied. First, when the amount of a change in PL is greater than a PL critical value or the amount of a change in PB is greater than a PB critical value, a condition 1 on PHR triggering is satisfied.

Meanwhile, the primary prohibition timer may prohibit not only PHR triggering by PL, but also PHR triggering by PB. Meanwhile, the secondary prohibition timer may prohibit only the PHR triggering by PB, but cannot prohibit PHR triggering by PL or periodic PHR triggering. Accordingly, whether the condition 2 is satisfied is differently interpreted according to what is the cause for triggering. In other words, the PHR triggering by PL is based on the condition 2 that the primary prohibition timer expires, and the PHR triggering by PB is based on the condition 2 that both the primary prohibition timer and the secondary prohibition timer expire. Accordingly, when the condition 2 is determined regarding a point of time An, only the primary prohibition timer is taken into account. When the condition 2 is determined regarding a point of time Bn, both the primary prohibition timer and the secondary prohibition timer are taken into account.

Whether a trigger condition for each point of time is satisfied may be determined as follows.

First, at a point of time A1, the condition 1 is satisfied because the amount of a change in PL is greater than a PL critical value, but the condition 2 is not satisfied because the primary prohibition timer has not expired Likewise, at points of time B1, B2, and B3, the condition 1 is satisfied because the amount of a change in PB is greater than a PH critical value, but the condition 2 is not satisfied because both the primary prohibition timer and the secondary prohibition timer have not yet expired. Accordingly, at the points of time A1, B1, B2, and B3, a PHR is not triggered.

Next, at a point of time A2, the condition 1 and the condition 2 are satisfied because the primary prohibition timer has expired. Accordingly, a PHR is triggered and transmitted (PHR Tx). Since the transmission of the PHR has been generated, the primary prohibition timer that has already expired is restarted, and the secondary prohibition timer before expiration is reset and restarted. At points of time B4, B5, and B6 before the primary prohibition timer and the secondary prohibition timer expire after they have been restarted, a PHR is not triggered because the condition 1 is satisfied, but the condition 2 is not satisfied.

At a point of time B7, the condition 1 is satisfied because the amount of a change in PB is greater than the PB critical value, and the condition 2 is also satisfied because both the primary prohibition timer and the secondary prohibition timer expire. Accordingly, a PHR based on the PB is triggered and transmitted. Since the transmission of the PHR has been generated, both the primary prohibition timer and the secondary prohibition timer are restarted at the point of time B7. An example in which the primary prohibition timer has a smaller value than the secondary prohibition timer has been described in FIG. 11, but the example is only illustrative. For example, the primary prohibition timer may have a greater value than the secondary prohibition timer.

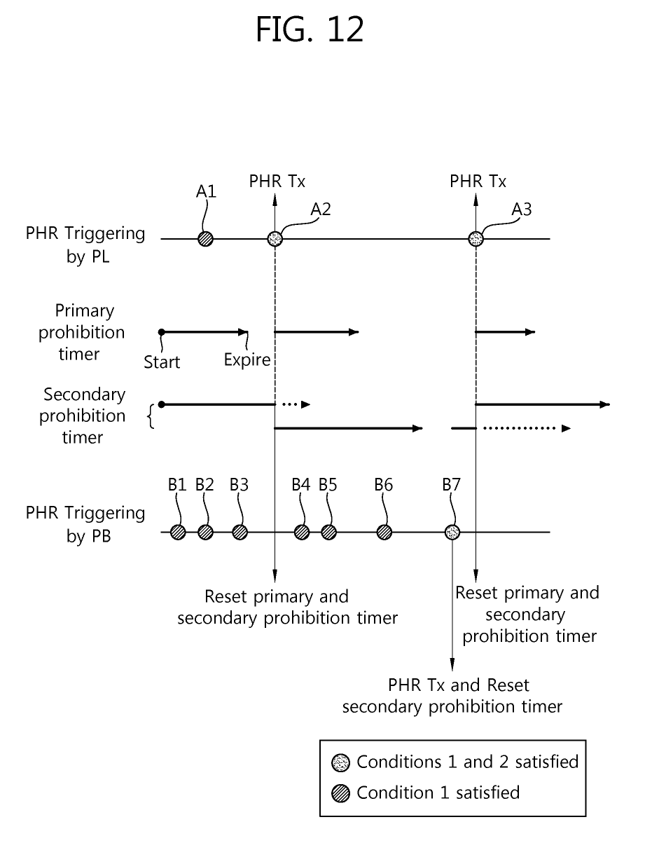

FIG. 12 is an explanatory diagram illustrating the trigger of a PHR according to yet another example of the present invention. FIG. 12 corresponds to an example in which the number of prohibition timers is two.

Referring to FIG. 12, a condition 1 and a condition 2 that a PHR is triggered are the same as that described with reference to FIG. 11, but differs from FIG. 11 in cause in which the primary prohibition timer and the secondary prohibition timer are restarted or reset. In FIG. 12, the transmission of a PHR based on PL resets or restarts both the primary prohibition timer and the secondary prohibition timer, and the transmission of a PHR based on PB restarts only the secondary prohibition timer, but does not restart the primary prohibition timer.

In other words, when the primary prohibition timer is reset or restarted, the secondary prohibition timer is also reset or restarted, but the primary prohibition timer is not reset or restarted although the secondary prohibition timer is reset or restarted.

Whether a trigger condition for each point of time is satisfied may be determined as follows.

First, at a point of time A1, the condition 1 is satisfied because the amount of a change in PL is greater than a PL critical value, but the condition 2 is not satisfied because the primary prohibition timer has not expired Likewise, at points of time B1, B2, and B3, the condition 1 is satisfied because the amount of a change in PB is greater than a PH critical value, but the condition 2 is not satisfied because both the primary prohibition timer and the secondary prohibition timer have not yet expired. Accordingly, at the points of time A1, B1, B2, and B3, a PHR is not triggered.

Next, at a point of time A2, the condition 1 and the condition 2 are satisfied because the primary prohibition timer has expired. Accordingly, a PHR is triggered and transmitted (PHR Tx). Since the transmission of the PHR has been generated, the primary prohibition timer that has already expired is restarted, and the secondary prohibition timer before expiration is reset and restarted. At points of time B4, B5, and B6 before the primary prohibition timer and the secondary prohibition timer expire after they have been restarted, a PHR is not triggered because the condition 1 is satisfied, but the condition 2 is not satisfied.

At a point of time B7, the condition 1 is satisfied because the amount of a change in PB is greater than the PB critical value, and the condition 2 is also satisfied because both the primary prohibition timer and the secondary prohibition timer expire. Accordingly, a PHR based on the PB is triggered and transmitted. The secondary prohibition timer is restarted. What the secondary prohibition timer is restarted is not a condition that the primary prohibition timer is restarted as described above, and thus the primary prohibition timer is not started.

Next, at a point of time A3, the condition 1 is satisfied because the amount of a change in PL is greater than the PL critical value, and the condition 2 is satisfied because the primary prohibition timer has expired. Accordingly, an MS triggers a PHR and transmits the PHR to a BS. At this time, the primary prohibition timer is restarted, and the secondary prohibition timer stops operating and it is reset and restarted.

An example in which the primary prohibition timer has a smaller value than the secondary prohibition timer has been described in FIG. 12, but the example is only illustrative. For example, the primary prohibition timer may have a greater value than the secondary prohibition timer.

As described above with reference to FIGS. 10 to 12, a point of time at which a PHR is triggered differs according to i) whether the number of prohibition timers is one or plural and ii) whether points of time at which a plurality of prohibition timers is restarted or reset are identical with or different from each other. For example, points of time at which a PHR is triggered are A2 and B6 in FIG. 10, A2 and B7 in FIG. 11, and A2, B7, and A3 in FIG. 12. If the amount of a change in PL is greater than the PL critical value or the amount of a change in PB is greater than the PB critical value as described above, the prohibition timer is taken into account in determining the condition 2 although the condition 1 that a PHR is triggered is satisfied. Accordingly, the determination of the condition 1 depends on a method of operating the prohibition timer.

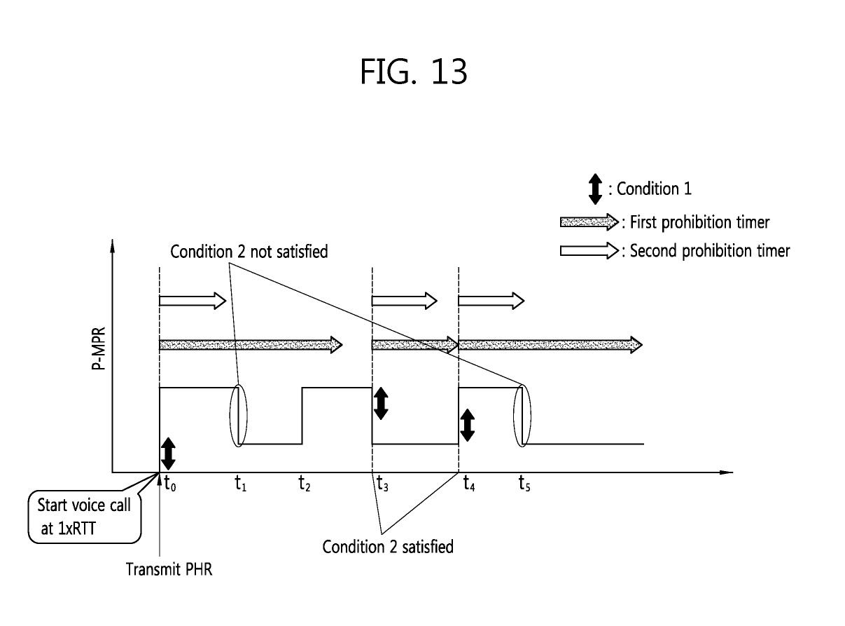

FIG. 13 is an explanatory diagram illustrating an embodiment in which a PHR is triggered by a plurality of prohibition timers according to the present invention. FIG. 13 corresponds to an example in which the number of prohibition timers operated based on PB is plural.

Referring to FIG. 13, PB (or P-MPR) is changed according to a lapse of time, and a condition 1 may include a case in which the amount of a change in PB is greater than a PB critical value or the amount of a change in PL is greater than a PL critical value. In an alternative, the condition 1 may be defined using a new standard amount.

It is hereinafter assumed that the condition 1 requires that the amount of a change in PB be greater than the PB critical value, for convenience of description. Meanwhile, PHR transmission is generated at a point of time at which both the condition 1 and a condition 2 are satisfied, and a first prohibition timer and a second prohibition timer are restarted at the same point of time whenever a PHR is transmitted. The first prohibition timer has a greater value than the second prohibition timer.

An MS applies the first prohibition timer when the amount of a change in PB is negative (−) and applies the second prohibition timer when the amount of a change in PB is positive (+). That is, the MS operates a plurality of prohibition timers for the amount of a change in PB. Accordingly, if any one of the following conditions 2A and 2B is satisfied, the condition 2 is satisfied. First, the condition 2A requires that the amount of a change in PB be negative (−) and the first prohibition timer expire. Second, the condition 2B requires that the amount of a change in PB be positive (+) and the second prohibition timer expire. Here, the amount of a change in PB refers to a difference between a PB value at a point of time at which the transmission of a PHR has occurred and a PB value at a point of time at which a trigger condition is determined.

For example, at a point of time t0, the trigger of a PHR and the transmission of the PHR are generated because the condition 1 and the condition 2 are satisfied. At this time, both the first and the second prohibition timer are restarted. Meanwhile, at a point of time t1, the condition 1 is satisfied because the amount of a change in PB (i.e., negative (−)) is greater than the PB critical value, but the condition 2A is not satisfied because the first prohibition timer has not expired. Accordingly, a PHR is not triggered. Meanwhile, the second prohibition timer does not influence the trigger of a PHR because it has expired at the point of time t1.

At a point of time t2, the PB value has more increased than the PB value at the point of time t1, but the amount of a change in PB is 0 because a point of time (i.e., a reference for the amount of a change in PB) is t0. Accordingly, the condition 1 is not satisfied. Next, at points of time t3 and t4, the trigger of a PHR and the transmission of the PHR are generated because the condition 1 and the condition 2 are satisfied.

As described above, the MS can control the trigger of a PHR by using the two prohibition timers differently applied when the amount of a change in PB is negative (−) and the amount of a change in PB is positive (+).

The concepts of the primary prohibition timer and the secondary prohibition timer in FIG. 11 or 12 may be applied to a PHR based on FIG. 13 without change.

For example, the first prohibition timer may become a primary prohibition timer, and the second prohibition timer may become a secondary prohibition timer. In this case, the first prohibition timer is operated like the primary prohibition timer of FIG. 11 or 12, and the second prohibition timer is operated like the secondary prohibition timer of FIG. 11 or 12. Accordingly, the trigger of a PHR is generated or prohibited.

For another example, the first prohibition timer may become a secondary prohibition timer, and the second prohibition timer may become a primary prohibition timer. In this case, the first prohibition timer is operated like the secondary prohibition timer of FIG. 11 or 12, and the second prohibition timer is operated like the primary prohibition timer of FIG. 11 or 12. Accordingly, the trigger of a PHR is generated or prohibited.

Meanwhile, even in case of an operation in conjunction with PHR triggering by PL, the description of FIG. 11 or 12 may be applied to FIG. 13 without change. For example, the first prohibition timer and the second prohibition timer may form a secondary prohibition timer, and a primary prohibition timer may exist separately from the first prohibition timer and the second prohibition timer in order to trigger a PHR. In this case, a PHR is not triggered before the primary prohibition timer expires although the first prohibition timer or the second prohibition timer expires. An operation, such as that shown in FIG. 13, is applied between the first prohibition timer and the second prohibition timer.

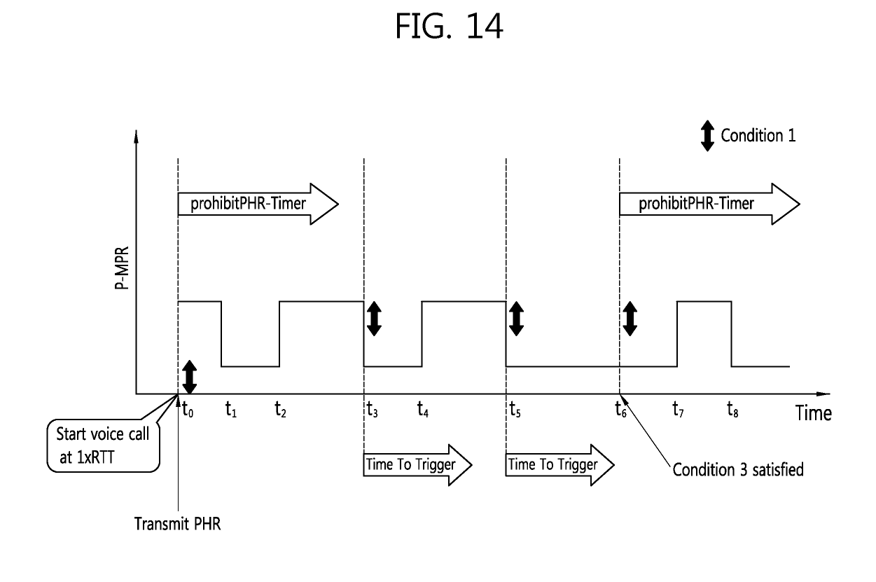

FIG. 14 is an explanatory diagram illustrating another embodiment in which a PHR is triggered by a plurality of prohibition timers according to the present invention. FIG. 14 corresponds to an example in which the PHR is triggered on condition that a state in which the PHR is possible continues for a specific time (i.e., Time To Trigger (TTT)).

Referring to FIG. 14, PB (P-MPR) is changed according to a lapse of time, and a condition 1 may include a case in which the amount of a change in PB is greater than a PB critical value or the amount of a change in PL is greater than a PL critical value. In an alternative, the condition 1 may be defined using a new standard amount. It is hereinafter assumed that the condition 1 requires that the amount of a change in PB be greater than the PB critical value, for convenience of description. Meanwhile, PHR transmission is generated at a point of time at which both the condition 1 and a condition 2 are satisfied, and a prohibition timer is restarted whenever the PHR is transmitted.

For example, at a point of time t0, the trigger of a PHR and the transmission of the PHR are generated because the condition 1, the condition 2, and a condition 3 are satisfied. At this time, a prohibition timer is restarted. The condition 3 is a new trigger condition, and the condition 3 requires that a state in which the condition 1 and the condition 2 are satisfied continue for a specific time TTT. That is, the point of time at which the PHR is triggered is not a point of time at which the condition 1 and the condition 2 are first satisfied, but a point of time at which a state in which the condition 1 and the condition 2 are satisfied continues for the TTT. This is because the occurrence of a change in the voice call state can be recognized only when a reduction of the PB value continues until the TTT elapses regarding the reduction.

At points of time t1 and t2, the condition 1 may be satisfied, but the condition 2 is not satisfied because the prohibition timer has not expired.

At a point of time t3, the condition 1 and the condition 2 are satisfied, but the condition 3 is satisfied only when the state in which the condition 1 and the condition 2 are satisfied continues for the TTT. However, the condition 1 does not continue because the PB value rises at a point of time t4 before the TTT expires. Accordingly, a PHR is not triggered because the condition 3 is not satisfied.

Meanwhile, at a point of time t5, the condition 1 and the condition 2 are satisfied, and the condition 3 is satisfied because the state in which the condition 1 and the condition 2 are satisfied continues for the TTT. Accordingly, an MS triggers a PHR at a point of time t6.

The description of FIGS. 10 to 12 may be applied to the case in which the PHR based on FIG. 14 is operated in conjunction with PHR triggering by PL, as in FIGS. 10 to 12, without change. For example, the prohibition timer in FIG. 14 may become the secondary prohibition timer in FIG. 11 or 12, and the trigger of a PHR is generated or prohibited as in FIG. 11 or 12. In this case, the TTR forming the condition 3 does not precede the primary prohibition timer. In other words, when the primary prohibition timer expires, a PHR based on PL or a periodic PHR may be triggered although the TTT does not expire.

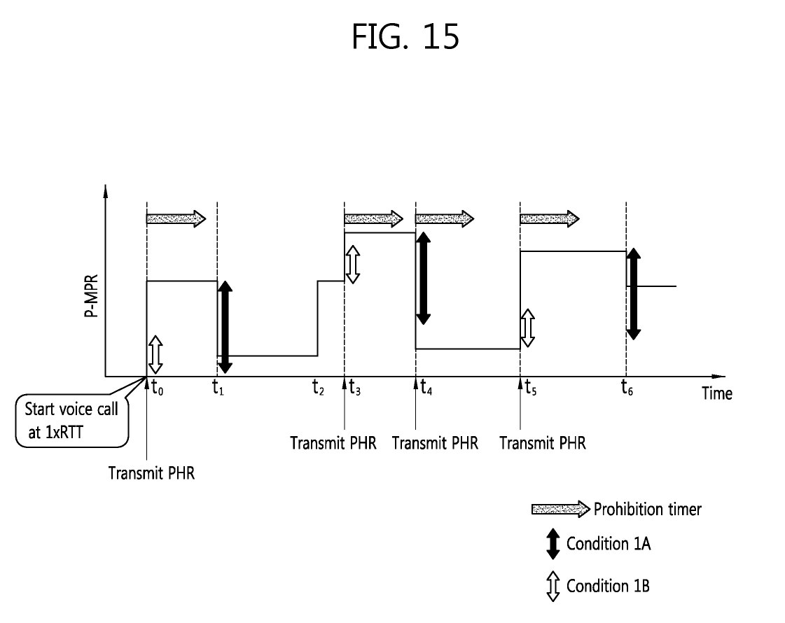

FIG. 15 is an explanatory diagram illustrating yet another embodiment in which a PHR is triggered by a plurality of prohibition timers according to the present invention. FIG. 15 corresponds to an example in which the number of amounts of a change in PB that trigger a PHR is plural.

Referring to FIG. 15, PB (or P-MPR) is changed according to a lapse of time, and a condition 1 requires that the amount of a change in reduction of a PB value be greater than a first critical value (condition 1A) and the amount of a change in increase of the PB value is greater than a second critical value (condition 1A). Here, the first critical value may be greater than or smaller than the second critical value.

The descriptions of FIGS. 10 to 12 may be applied to a case in which PHR triggering by PB according to the condition 1A and the condition 1B is operated in conjunction with PHR triggering by PL as in FIGS. 10 to 12. For example, the prohibition timer in FIG. 15 may become the secondary prohibition timer in FIG. 11 or 12, and the trigger of a PHR is generated or prohibited as in FIG. 11 or 12.

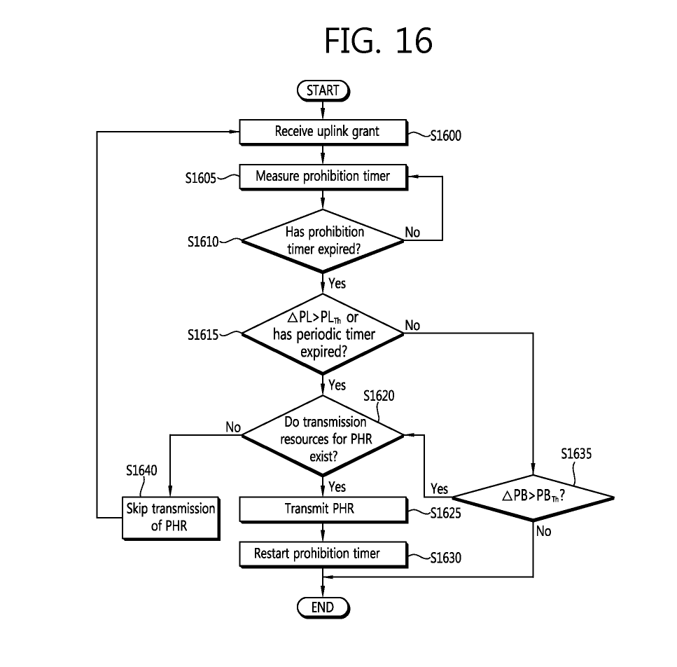

FIG. 16 is a flowchart illustrating a method of an MS performing a PHR according to an example of the present invention. FIG. 16 corresponds to an example in which the number of prohibition timers is one.

Referring to FIG. 16, the MS receives an uplink grant from a BS at step S1600. The uplink grant is transmitted on a PDCCH in the form of Downlink Control Information (DCI) having a format 0 to 4 for the allocation of uplink resources to the MS. The uplink grant is configured as in Table 4 below.

TABLE 4
- Flag for format0/format1A differentiation − 1 bit, where value 0 indicates format 0 and value 1

indicates format 1A

- Frequency hopping flag − 1 bit
- Resource block assignment and hopping resource allocation − ┌log₂ (N_{RB}^{UL} (N_{RB}^{UL} + 1)/2)┐ bits

- For PUSCH hopping:
- N_{UL}_{_{—}}ₕₒₚ MSB bits are used to obtain the value of ñ_{PRB}(i)

- (┌log₂ (N_{RB}^{UL} (N_{RB}^{UL} + 1)/2)┐ − N_{UL}_{_{—}}ₕₒₚ) bits provide the resource allocation of the first slot in the
UL subframe

- For non-hopping PUSCH:

- (┌log₂ (N_{RB}^{UL} (N_{RB}^{UL} + 1)/2)┐ ) bits provide the resource allocation in the UL subframe

- Modulation and coding scheme and redundancy version − 5 bits
- New data indicator − 1 bit
- TPC command for scheduled PUSCH − 2 bits
- Cyclic shift for DMRS − 3 bits
- UL index − 2 bits (this field is present only for TDD operation with uplink-downlink configuration 0)

| | |
|---|---|
| - | Downlink Assignment Index (DAI) − 2 bits (this field is present only for TDD operation with uplink- |
| | downlink configurations 1-6) |

- CQI request - 1 bit
- Carrier Index Field (CIF) − 3 bits(this field is present only for Carrier Aggregation)

Referring to Table 4, the uplink grant includes pieces of information, such as RB, an MCS, and TPC.

The MS measures a current prohibition timer at step S1605. A point of time at which the prohibition timer is started or restarted has been described above. The current prohibition timer may be measured by the subframe.

The MS determines whether the prohibition timer has expired on the basis of the measurement value of the prohibition timer at step S1610. If, as a result of the determination at step S1610, the prohibition timer is determined not to have expired, it means that the condition 2 for triggering is not satisfied, and thus the MS returns back to step S1605. If, as a result of the determination at step S1610, the prohibition timer is determined to have expired, the condition 2 for triggering has been satisfied. Accordingly, the MS compares the amount of a change in PL (ΔPL) with a PL critical value PL_{TH} and determines whether a periodic timer has expired at step S1615.

If, as a result of the determination at step S1615, ΔPL is determined to be greater than PL_{TH} (i.e., ΔPL>PL_{TH}), the condition 1 for triggering is satisfied. Alternatively, if the periodic timer expires, a PHR may be triggered. If uplink resources do not exist even though the condition 1 and the condition 2 for triggering are satisfied, the MS cannot transmit a PHR. Accordingly, the MS determines whether uplink resources on which the PHR will be transmitted have been secured at step S1620. If, as a result of the determination at step S1620, the uplink resources are determined to have been secured, the MS transmits the PHR to the BS at step S1625. Next, the MS restarts the prohibition timer at step S1630. Alternatively, when the periodic timer expires at step S1615, PHR triggering may be generated.

If, as a result of the determination at step S1620, the uplink resources are determined not to have been secured, the MS skips the transmission of the PHR at step S1640.

If, as a result of the determination at step S1615, ΔPL is determined not to be greater than PL_{TH}, the MS compares the amount of a change in PB ΔPB with a PB critical value PB_{TH} at step S1635. If, as a result of comparison at step S1635, ΔPB is determined to be greater than PB_{TH} (i.e., ΔPB>PB_{TH}), the condition 1 for triggering is satisfied. Accordingly, the MS returns back to step S1620. If, as a result of comparison at step S1635, ΔPB is determined not to be greater than PB_{TH}, the MS terminates the procedure because the condition 1 for triggering is not satisfied.

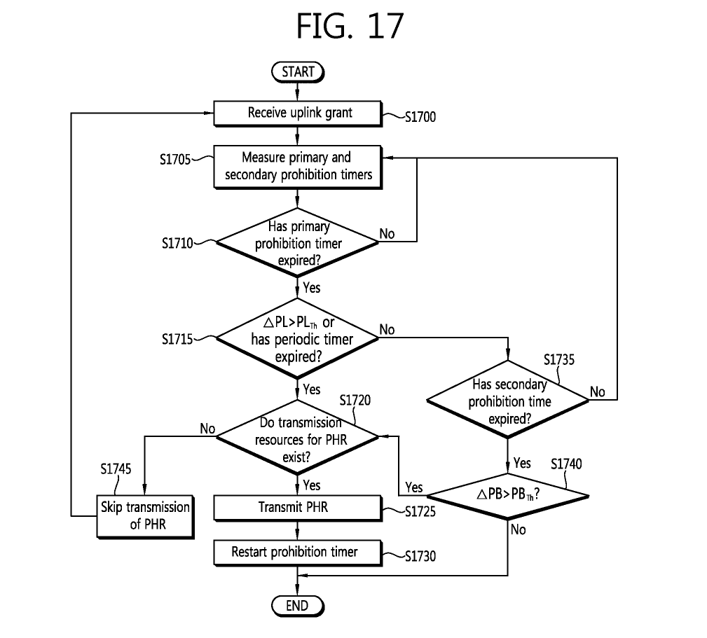

FIG. 17 is a flowchart illustrating a method of an MS performing a PHR according to another example of the present invention. FIG. 17 corresponds to an example in which the number of prohibition timers is 2 (i.e., a primary prohibition timer and a secondary prohibition timer) and both the prohibition timers are reset or restarted by PHR triggering as in FIG. 11.

Referring to FIG. 17, the MS receives an uplink grant from a BS at step S1700. The MS measures the primary prohibition timer and the secondary prohibition timer at the present time at step S1705.

The MS determines whether the primary prohibition timer has expired on the basis of the measured values of the primary prohibition timer and the secondary prohibition timer at step S1710. If, as a result of the determination at step S1710, the primary prohibition timer is determined to have expired, it means that the condition 2 for triggering is satisfied, and thus the MS compares the amount of a change in PL ΔPL with a PL critical value PL_{TH} at step S1715. In an alternative, the MS determines whether a periodic timer has expired. In another alternative, a PHR may be triggered even when the periodic timer is determined to have expired at step S1715.

If, as a result of the determination at step S1715, ΔPL is determined to be greater than PL_{TH} (i.e., ΔPL>PL_{TH}), the condition 1 for triggering is satisfied. In an alternative, when the periodic timer expires, the PHR may be triggered. However, the PHR cannot be transmitted if uplink resources do not exist although the condition 1 and the condition 2 for triggering are satisfied. Accordingly, the MS determines whether the uplink resources for transmitting the PHR have been secured at step S1720. If, as a result of the determination at step S1720, the uplink resources are determined to have been secured, the MS transmits the PHR to the BS at step S1725. Next, the MS restarts both the primary prohibition timer and the secondary prohibition timer at step S1730. In other words, when the PHR is transmitted, both the primary prohibition timer and the secondary prohibition timer are restarted. In this case, it does not matter what the cause of triggering the PHR.

If, as a result of the determination at step S1720, the uplink resources are determined not to have been secured, the MS skips the transmission of the PHR at step S1745.

If, as a result of the determination at step S1715, ΔPL is determined not to be greater than PL_{TH}, it means that the condition 1 for triggering is satisfied, and thus the MS determines whether the secondary prohibition timer has expired at step S1735. If, as a result of the determination at step S1735, the secondary prohibition timer is determined not to have expired, it means that the condition 2 for triggering is not satisfied, and thus the MS returns back to step S1705. If, as a result of the determination at step S1735, the secondary prohibition timer is determined to have expired, it means that the condition 2 for triggering is satisfied, and thus the MS compares the amount of a change in PB ΔPB with a PB critical value PB_{TH} at step S1740. If, as a result of the determination at step S1740, ΔPB is determined to be greater than PB_{TH} (i.e., ΔPB>PB_{TH}), it means that the condition 1 for triggering is satisfied, and thus the MS returns back to step S1720. If, as a result of the determination at step S1740, ΔPB is determined not to be greater than PB_{TH}, it means that the condition 1 for triggering is not satisfied, and thus the MS terminates the procedure.

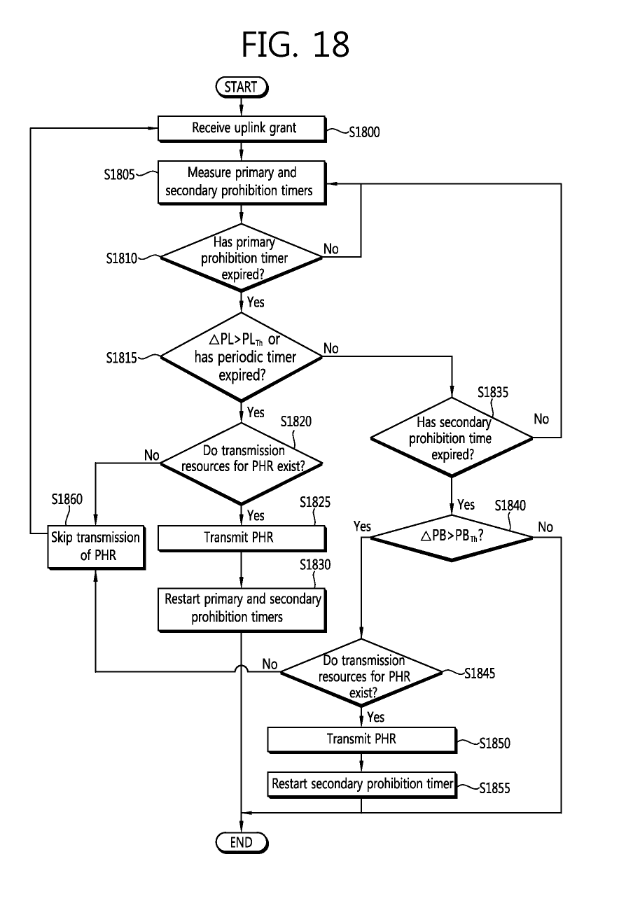

FIG. 18 is a flowchart illustrating a method of an MS performing a PHR according to yet another example of the present invention. FIG. 18 corresponds to an example in which the number of prohibition timers is 2 (i.e., a primary prohibition timer and a secondary prohibition timer) and both the prohibition timers are individually reset or restarted as in FIG. 12.

Referring to FIG. 18, the MS receives an uplink grant from a BS at step S1800. The MS measures the primary prohibition timer and the secondary prohibition timer at the present time at step S1805.

The MS determines whether the primary prohibition timer has expired on the basis of the measured values of the primary prohibition timer and the secondary prohibition timer at step S1810. If, as a result of the determination at step S1810, the primary prohibition timer is determined not to have expired, it means that the condition 2 for triggering is not satisfied, and thus the MS returns back to step S1805. If, as a result of the determination at step S1810, the primary prohibition timer is determined to have expired, it means that the condition 2 for triggering is satisfied, and thus the MS compares the amount of a change in PL ΔPL with a PL critical value PL_{TH} at step S1815. In an alternative, the MS determines whether a periodic timer has expired. In another alternative, a PHR may be triggered even when the periodic timer is determined to have expired at step S1815.

If, as a result of the determination at step S1815, ΔPL is determined to be greater than PL_{TH} (i.e., ΔPL>PL_{TH}), it means that the condition 1 for triggering is satisfied. In an alternative, if the periodic timer is determined to have expired, a PHR may be triggered. However, if uplink resources do not exist although the condition 1 and the condition 2 for triggering are satisfied, the PHR cannot be transmitted. Accordingly, the MS determines whether the uplink resources for transmitting the PHR have been secured at step S1820. If, as a result of the determination at step S1819, the uplink resources are determined to have been secured, the MS transmits the PHR to the BS at step S1825. Next, the MS restarts both the primary prohibition timer and the secondary prohibition timer at step S1830. In other words, when the transmission of the PHR based on the PL is generated, both the primary prohibition timer and the secondary prohibition timer are restarted.

If, as a result of the determination at step S1820, the uplink resources are determined not to have been secured, the MS skips the transmission of the PHR at step S1860.

If, as a result of the determination at step S1815, ΔPL is determined not to be greater than PL_{TH}, it means that the condition 1 for triggering is not satisfied. The MS determines whether the secondary prohibition timer has expired at step S1835. If, as a result of the determination at step S1835, the secondary prohibition timer is determined not to have expired, it means that the condition 2 for triggering is not satisfied, and thus the MS returns back to step S1805. If, as a result of the determination at step S1835, the secondary prohibition timer is determined to have expired, it means that the condition 2 for triggering is satisfied, and thus the MS compares the amount of a change in PB ΔPB with a PB critical value PB_{TH} at step S1840. If, as a result of the determination at step S1840, ΔPB is determined not to be greater than PB_{TH}, it means that the condition 1 for triggering is not satisfied, and thus the MS terminates the procedure.

If, as a result of the determination at step S1840, ΔPB is determined to be greater than PB_{TH} (i.e., ΔPB>PB_{TH}), it means that the condition 1 for triggering is satisfied, and thus the MS determines whether uplink resources for transmitting the PHR have been secured at step S1845. If, as a result of the determination at step S1845, the uplink resources are determined not to have been secured, the MS skips the transmission of the PHR at step S1860. If, as a result of the determination at step S1845, the uplink resources are determined to have been secured, the MS transmits the PHR to the BS at step S1850. Next, the MS restarts the secondary prohibition timer at step S1855. In other words, when the transmission of the PHR based on the PB is generated, only the secondary prohibition timer is restarted, but the primary prohibition timer is not influenced.

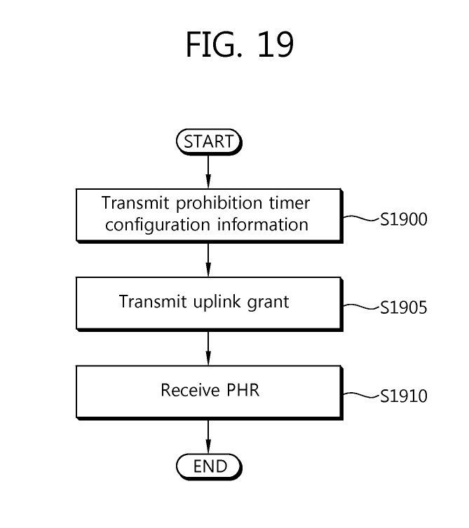

FIG. 19 is a flowchart illustrating a method of a BS performing a PHR according to an example of the present invention.

Referring to FIG. 19, the BS transmits prohibition timer configuration information to an MS at step S1900. The prohibition timer configuration information includes information about the length of each of a primary prohibition timer and a secondary prohibition timer. The length of each of the primary prohibition timer and the secondary prohibition timer may be a subframe unit. The prohibition timer configuration information is an RRC message, and it may have a form, such as that shown in Table 2 or 3.

The BS transmits an uplink grant to the MS at step S1905. The uplink grant may have a form, such as that shown in Table 4.

The BS receives a PHR, transmitted through uplink resources allocated based on the uplink grant, from the MS at step S1910.

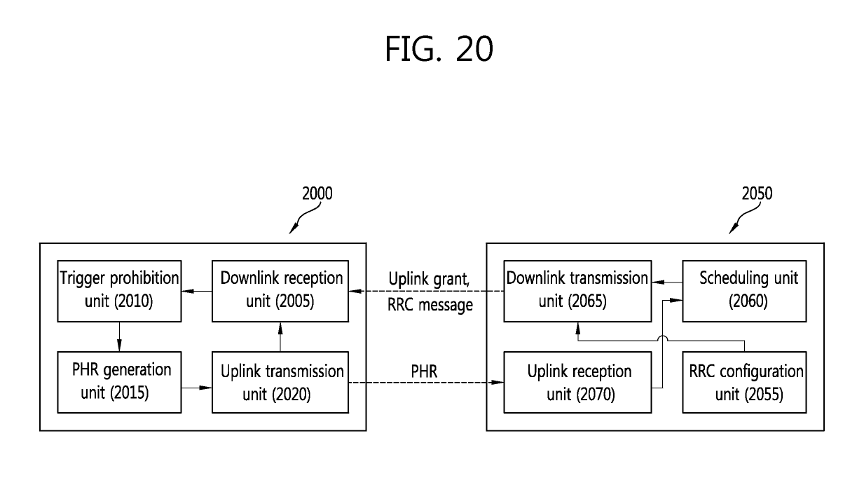

FIG. 20 is a block diagram of an MS and a BS which perform a PHR according to an example of the present invention.

Referring to FIG. 20, the MS 2000 includes a downlink reception unit 2005, a trigger prohibition unit 2010, a PHR generation unit 2015, and an uplink transmission unit 2020.

The downlink reception unit 2005 receives an uplink grant or an RRC message from a BS 2050. The RRC message includes prohibition timer configuration information or an information element MAC-MainConfig. For example, the RRC message may have a form, such as that shown in Table 2 or 3.

The trigger prohibition unit 2010 measures the amount of a change in PL for a secondary serving cell, configured in the MS 2000, and the amount of a change in PB, configured in the MS 2000, measures a primary prohibition timer and a secondary prohibition timer used to prohibit the trigger of a PHR, and generates or prohibits at least one of the trigger of a first PHR based on the amount of a change in PL and the trigger of a second PHR based on the amount of a change in PB on the basis of the states of the primary prohibition timer and the secondary prohibition timer.

For example, if the primary prohibition timer has not expired, the trigger prohibition unit 2010 may prohibit both the trigger of the first PHR and the trigger of the second PHR. In an alternative, the trigger prohibition unit 2010 generates or prohibits the trigger of the second PHR on the basis of the state of the secondary prohibition timer. Furthermore, when any one of the first PHR and the second PHR is triggered and transmitted, the trigger prohibition unit 2010 restarts at least one of the primary prohibition timer and the secondary prohibition timer.

More specifically, the trigger prohibition unit 2010 may prohibit or generate trigger of the PHR according to any one of the procedures described with reference to FIGS. 16 to 18. That is, the trigger prohibition unit 2010 determines that the trigger condition 1 is satisfied if the amount of a change in PL is greater than a PL critical value or the amount of a change in PB is greater than a PB critical value and determines that the trigger condition 2 is satisfied if the primary prohibition timer and the secondary prohibition timer expire.

If the trigger condition is not satisfied, the trigger prohibition unit 2010 prohibits the trigger of the PHR. If the trigger condition is satisfied, the trigger prohibition unit 2010 triggers the PHR and informs the PHR generation unit 2015 of the trigger of the PHR.

The PHR generation unit 2015 generates an MAC CE for the PHR and transfers the MAC CE to the uplink transmission unit 2020.

The uplink transmission unit 2020 transmits the generated MAC CE to the BS 2050.

The BS 2050 includes an RRC configuration unit 2055, a scheduling unit 2060, a downlink transmission unit 2065, and an uplink reception unit 2070.

The RRC configuration unit 2055 configures a prohibition timer, generates an RRC message including information about the prohibition timer, and transmits the RRC message to the downlink transmission unit 2065.

The scheduling unit 2060 performs uplink scheduling for the MS 2000 and generates an uplink grant to be transmitted through a PDCCH.

The downlink transmission unit 2065 transmits the RRC message or the uplink grant to the MS 2000.

The uplink reception unit 2070 receives the PHR, transmitted in response to triggering, from the MS 2000.

While some exemplary embodiments of the present invention have been described with reference to the accompanying drawings, those skilled in the art may change and modify the present invention in various ways without departing from the essential characteristic of the present invention. Accordingly, the disclosed embodiments should not be construed to limit the technical spirit of the present invention, but should be construed to illustrate the technical spirit of the present invention. The scope of the technical spirit of the present invention is not limited by the embodiments, and the scope of the present invention should be interpreted based on the following appended claims. Accordingly, the present invention should be construed to cover all modifications or variations induced from the meaning and scope of the appended claims and their equivalents.

1. A User Equipment (UE) performing a Power Headroom Report (PHR), comprising:
a trigger prohibition unit for determining whether a prohibition timer used to prohibit a trigger of the PHR expires or has expired, for measuring an amount of a change in Power Backoff (PB) for the UE, and for generating a trigger of the PHR based on the prohibit timer and the amount of the change in the PB; and
an uplink transmission unit for transmitting a Medium Access Control (MAC) message, including the PHR, to an evolved NodeB (eNB) based on the trigger of the PHR.

2. The UE as claimed in claim 1, wherein the trigger prohibition unit generates the trigger of the PHR, if the prohibit timer expires or has expired, and the amount of the change in the PB for the UE is greater than a threshold value.

3. The UE as claimed in claim 2, wherein the PHR includes information on the P_{CMAX} and P_{CMAX}_{_{—}}_{L}, wherein the P_{CMAX} is the maximum transmission power configured in the UE, and the P_{CMAX}_{_{—}}_{L} is a minimum value of the P_{CMAX}.

4. The UE as claimed in claim 3, wherein P_{CMAX}_{_{—}}_{L} is calculated by Equation (E-1),
P_{CMAX}_{_{—}}_{L}=MIN[P_{EMAX}−ΔT_{C},P_{powerclass}−MAX[MPR+AMPR,PMPR]−ΔT_{C}] (E-1)
wherein, MIN[a,b] is a smaller value of ‘a’ and ‘b’, P_{EMAX} is a maximum power determined by a RRC signaling of the UE, and ΔT_{C} is an amount of power applied when there is uplink transmission at the edge of a band, ΔT_{C} has 1.5 dB or 0 dB according to a bandwidth P_{powerclass} is a power value according several power classes that have been defined in a system, MAX[a,b] is a larger value of ‘a’ and ‘b’, MPR is an amount of a maximum power reduction, and AMPR is an amount of an additional maximum power reduction signalized by the eNB, PMPR is a value of the PB.

5. The UE as claimed in claim 2, wherein the trigger prohibition unit generates the trigger of the PHR, further if the change in the PB continues until a specific time elapses, when the change in the PB indicates decrease of the PB.

6. A method of a User Equipment (UE) performing a Power Headroom Report (PHR), comprising:
determining whether a prohibition timer used to prohibit a trigger of the PHR expires or has expired;
measuring an amount of a change in Power Backoff (PB) for the UE;
generating a trigger of the PHR based on the prohibit timer and the amount of the change in the PB;
transmitting a Medium Access Control (MAC) message, including the PHR, to an evolved NodeB (eNB) based on the trigger of the PHR.

7. The method as claimed in claim 6, wherein generating the trigger of the PHR is performed, if the prohibit timer expires or has expired, and the amount of the change in the PB for the UE is greater than a threshold value.

8. The method as claimed in claim 7, wherein the PHR includes information on the P_{CMAX} and P_{CMAX}_{_{—}}_{L}, wherein the P_{CMAX} is the maximum transmission power configured in the UE and the P_{CMAX}_{_{—}}_{L} is a minimum value of the P_{CMAX}.

9. The method as claimed in claim 8, wherein P_{CMAX}_{_{—}}_{L} is calculated by Equation (E-2),
P_{CMAX}_{_{—}}_{L}=MIN[P_{EMAX}−ΔT_{C},P_{powerclass}−MAX[MPR+AMPR,PMPR]−ΔT_{C}] (E-2)
wherein, MIN[a,b] is a smaller value of ‘a’ and ‘b’, P_{EMAX} is a maximum power determined by a RRC signaling of the UE, and ΔT_{C} is an amount of power applied when there is uplink transmission at the edge of a band ΔT_{C} has 1.5 dB or 0 dB according to a bandwidth P_{powerclass} is a power value according several power classes that have been defined in a system, MAX[a,b] is a larger value of ‘a’ and ‘b’, MPR is an amount of a maximum power reduction, and AMPR is an amount of an additional maximum power reduction signalized by the eNB, PMPR is a value of the PB.

10. The method as claimed in claim 7, wherein the generating the trigger of the PHR is performed, further if the change in the PB continues until a specific time elapses, when the change in the PB indicates decrease of the PB.

11. An evolved NodeB (eNB) receiving a Power Headroom Report (PHR), comprising:
a Radio Resource Control (RRC) configuration unit for generating an RRC message including prohibition timer configuration information including information about a length of a prohibition timer which are used to prohibit a trigger of the PHR;
a scheduling unit for performing uplink scheduling for a User Equipment (UE) and generating an uplink grant;
a downlink transmission unit for transmitting the RRC message and the uplink grant to the UE; and
an uplink reception unit for receiving the PHR from the UE through uplink resources based on the uplink grant,
wherein, the uplink reception unit receives the PHR, when the prohibit timer expires or has expired, and an amount of the change in Power Backoff (PB) for the UE is greater than a threshold value.

12. The eNB as claimed in claim 11, wherein the PHR includes information on the P_{CMAX} and P_{CMAX}_{_{—}}_{L} wherein the P_{CMAX} is the maximum transmission power configured in the UE, and the P_{CMAX}_{_{—}}_{L} is a minimum value of the P_{CMAX}.

13. The eNB as claimed in claim 12, wherein P_{CMAX}_{_{—}}_{L} is calculated by Equation (E-3),
P_{CMAX}_{_{—}}_{L}=MIN[P_{EMAX}−ΔT_{C},P_{powerclass}−MAX[MPR+AMPR,PMPR]−ΔT_{C}] (E-3)
wherein, MIN[a,b] is a smaller value of ‘a’ and ‘b’ P_{EMAX} is a maximum power determined by a RRC signaling of the UE, and ΔT_{C} is an amount of power applied when there is uplink transmission at the edge of a band ΔT_{C} has 1.5 dB or 0 dB according to a bandwidth P_{powerclass} is a power value according several power classes that have been defined in a system, MAX[a,b] is a larger value of ‘a’ and ‘b’, MPR is an amount of a maximum power reduction, and AMPR is an amount of an additional maximum power reduction signalized by the eNB, PMPR is a value of the PB.

14. The eNB as claimed in claim 12, wherein the uplink reception unit receives the PHR, further when the change in the PB continues until a specific time elapses, if the change in the PB indicates decrease of the PB.

15. A method of a eNB (evolved NodeB) receiving a Power Headroom Report (PHR), comprising:
generating a Radio Resource Control (RRC) message including prohibition timer configuration information including information about a length of a prohibition timer which are used to prohibit a trigger of the PHR;
performing uplink scheduling for a User Equipment (UE) and generating an uplink grant;
transmitting the RRC message and the uplink grant to the UE; and
receiving the PHR from the UE through uplink resources based on the uplink grant,
wherein, the receiving the PHR from the UE is performed, when the prohibit timer expires or has expired, and an amount of the change in Power Backoff (PB) for the UE is greater than a threshold value.

16. The method as claimed in claim 15, wherein the PHR includes information on the P_{CMAX} and P_{CMAX}_{_{—}}_{L} wherein the P_{CMAX} is the maximum transmission power configured in the UE, and the P_{CMAX}_{_{—}}_{L} is a minimum value of the P_{CMAX}.

17. The method as claimed in claim 16, wherein P_{CMAX}_{_{—}}_{L} is calculated by Equation (E-4),
P_{CMAX}_{_{—}}_{L}=MIN[P_{EMAX}−ΔT_{C},P_{powerclass}−MAX[MPR+AMPR,PMPR]−ΔT_{C}] (E-4)
wherein, MIN[a,b] is a smaller value of ‘a’ and ‘b’, P_{EMAX} is a maximum power determined a RRC signaling of the UE and ΔT_{C} is an amount of power a lied when there is uplink transmission at the edge of a band, ΔT_{c} has 1.5 dB or 0 dB according to a bandwidth, P_{powerclass} is a power value according several power classes that have been defined in a system, MAX[a,b] is a larger value of ‘a’ and ‘b’, MPR is an amount of a maximum power reduction, and AMPR is an amount of an additional maximum power reduction signalized by the eNB, PMPR is a value of the PB.

18. The method as claimed in claim 16, wherein the receiving the PHR is performed, further when the change in the PB continues until a specific time elapses, if the change in the PB indicates decrease of the PB.

19.-20. (canceled)
